(19) United States
(12) Patent Application Publication
(10) Pub. No.: US 2010/0141752 A1
(43) Pub. Date: Jun. 10, 2010

(54) Microscope System, Specimen Observing Method, and Computer Program Product

(76) Inventors: Tatsuki Yamada, Tokyo (JP); Shinsuke Tani, Tokyo (JP); Takeshi Otsuka, Tokyo (JP); Satoshi Arai, Tokyo (JP); Yuichi Ishikawa, Tokyo (JP); Kengo Takeuchi, Tokyo (JP)

Correspondence Address: GIBBONS P.C., ONE GATEWAY CENTER, NEWARK, NJ, 07102, US

(21) Appl. No.: 12/629,547

(22) Filed: Dec. 2, 2009

(30) Foreign Application Priority Data
Dec. 4, 2008 (JP) 2008-310136

(51) Int. Cl. G09G 5/02; H04N 7/18; G09G 5/00

(52) U.S. Cl. 348/79; 348/254; 345/589; 348/E07.085; 345/660

(57) ABSTRACT

A microscope system includes an image acquiring unit that acquires a specimen image formed by capturing a specimen multi-stained by a plurality of pigments using a microscope; a pigment amount acquiring unit that acquires a pigment amount of each pigment staining a corresponding position on the specimen, for each pixel of the specimen image; and a pigment selecting unit that selects a display target pigment from the plurality of pigments. The system also includes a display image generating unit that generates a display image where a staining state of the specimen by the display target pigment is displayed, on the basis of the pigment amount of the display target pigment in each pixel of the specimen image; and a display processing unit that displays the display image on a display unit.

### CROSS-REFERENCE TO RELATED APPLICATIONS

This application is based upon and claims the benefit of priority from Japanese Patent Application No. 2008-310136, filed on Dec. 4, 2008, the entire contents of which are incorporated herein by reference.

### BACKGROUND OF THE INVENTION

1. Field of the Invention

The present invention relates to a microscope system that acquires a specimen image by capturing a specimen multi-stained by a plurality of pigments using a microscope, displays the acquired specimen image, and observes the specimen, a specimen observing method, and a computer program product.

2. Description of the Related Art

For example, in pathological diagnosis, a system that creates a specimen by thinly slicing a tissue specimen obtained by removing an organ or performing a needle biopsy with the thickness of approximately several micrometers and performs a magnifying observation using an optical microscope for acquiring various findings has been widely performed. In this case, since the specimen rarely absorb and scatter light and is nearly clear and colorless, the specimen is generally stained by a pigment before the observation.

Conventionally, various types of staining methods have been suggested. However, regarding especially the tissue specimen, hematoxylin eosin staining (hereinafter, referred to as “HE staining”) using two pigments of hematoxylin and eosin is generally used as morphological observation staining for a morphological observation of the specimen. For example, a method that captures the specimen subjected to the HE staining with multi-bands, estimates a spectral spectrum of a specimen position to calculate (estimate) the pigment amount of the pigment staining the specimen, and synthesizes R, G, and B images for display is disclosed (for example, refer to Japanese Unexamined Patent Application Publication No. 2008-51654, Japanese Unexamined Patent Application Publication No. 7-120324, and Japanese Unexamined Patent Application Publication No. 2002-521682). As another morphological observation staining, for example, in cytological diagnosis, Papanicolaou staining (Pap staining) is known.

In the pathological diagnosis, molecule target staining to confirm an expression of molecule information is performed on the specimen to be used for diagnosis of function abnormality, such as expression abnormality of a gene or a protein. For example, the specimen is fluorescently labeled using an IHC (immunohistochemistry) method, an ICC (immunocytochemistry) method, and an ISH (in situ hybridization) method and fluorescently observed, or is enzyme-labeled and observed in a bright field. In this case, in the fluorescent observation of the specimen by the fluorescent labeling, for example, a confocal laser microscope is used.

Meanwhile, in the bright field observation (the IHC method, the ICC method, and the CISH method) by the enzyme labeling, the specimen can be semi-permanently held. Since an optical microscope is used, the observation can be performed together with the morphological observation, and is used as the standard in the pathological diagnosis.

When the specimen is observed using a microscope, a one-time observable range (viewing range) is mainly determined by a magnification of an objective lens. In this case, if the magnification of the objective lens is high, a high-resolution image can be obtained, but the viewing range is narrowed. In order to resolve this problem, a microscope system that is called a virtual microscope system has been known. In the virtual microscope system, each portion of the specimen image is captured using an objective lens having a high magnification, while changing the viewing range by moving an electromotive stage to load the specimen. In addition, a specimen image having high resolution and a wide field is generated by synthesizing the individual captured partial specimen images (for example, refer to Japanese Unexamined Patent Application Publication No. 9-281405 (FIG. 5)). Hereinafter, the specimen image that is generated in the virtual microscope system is called a “VS image”.

According to the virtual microscope system, for example, the generated VS image can be opened to be readable through a network, and thus the specimen can be observed without depending on a time and a place. For this reason, the virtual microscope system is practically used in the field of education of the pathological diagnosis or a consultation between pathologists in a remote place.

### SUMMARY OF THE INVENTION

A microscope system according to an aspect of the present invention includes an image acquiring unit that acquires a specimen image formed by capturing a specimen multi-stained by a plurality of pigments using a microscope; a pigment amount acquiring unit that acquires a pigment amount of each pigment staining a corresponding position on the specimen, for each pixel of the specimen image; a pigment selecting unit that selects a display target pigment from the plurality of pigments; a display image generating unit that generates a display image where a staining state of the specimen by the display target pigment is displayed, on the basis of the pigment amount of the display target pigment in each pixel of the specimen image; and a display processing unit that displays the display image on a display unit.

A specimen observing method according to another aspect of the present invention includes acquiring a pigment amount of each pigment staining a corresponding position on a specimen, for each pixel of a specimen image obtained by capturing a specimen multi-stained by a plurality of pigments; a pigment selecting unit that selects a display target pigment from the plurality of pigments; a display image generating unit that generates a display image where a staining state of the specimen by the display target pigment is displayed, on the basis of the pigment amount of the display target pigment in each pixel of the specimen image; and a display processing unit that displays the display image on a display unit.

A computer program product according to still another aspect of the present invention causes a computer to perform the method according to the present invention.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating an example of the entire configuration of a microscope system according to a first embodiment of the invention;

FIG. 2 is a schematic diagram illustrating the configuration of a filter unit;

FIG. 3 is a diagram illustrating a spectral transmittance characteristic of one optical filter;

FIG. 4 is a diagram illustrating a spectral transmittance characteristic of the other optical filter;

FIG. 5 is a diagram illustrating an example of spectral sensitivity of each band for R, G, and B;

FIG. 6 is a flowchart illustrating the operation of the microscope system in the first embodiment;

FIG. 7 is a diagram illustrating an example of a slide glass specimen;

FIG. 8 is a diagram illustrating an example of a specimen area image;

FIG. 9 is a diagram illustrating an example of the data configuration of a focus map;

FIG. 10 is a diagram illustrating an example of the data configuration of a VS image file in the first embodiment;

FIG. 11 is a diagram illustrating another example of the data configuration of the VS image file in the first embodiment;

FIG. 12 is a diagram illustrating still another example of the data configuration of the VS image file in the first embodiment;

FIG. 13 is a flowchart illustrating a process sequence of a calculating process of the pigment amount in the first embodiment;

FIG. 14 is a flowchart illustrating a process sequence of a display process of a VS image in the first embodiment;

FIG. 15 is a diagram illustrating an example of a pigment registration screen used to notify a registration request of a staining pigment of a specimen;

FIG. 16 is a diagram illustrating an example of a VS image observation screen;

FIG. 17 is a diagram illustrating an example of a main screen that is switched by pressing a display switching button;

FIG. 18 is a diagram illustrating a main functional block of a host system according to a second embodiment of the invention;

FIG. 19 is a diagram illustrating an example of a pigment correction screen;

FIG. 20 is a diagram illustrating another example of a correction coefficient adjustment screen;

FIG. 21 is a diagram illustrating an example of a look-up table;

FIG. 22 is a diagram illustrating another example of the look-up table;

FIG. 23 is a diagram illustrating a main functional block of a host system according to a third embodiment of the invention;

FIG. 24 is a diagram illustrating an example of a spectrum of a pseudo display color;

FIG. 25 is a flowchart illustrating a process sequence of a display process of a VS image in the third embodiment;

FIG. 26 is a diagram illustrating a main functional block of a host system according to a fourth embodiment of the invention;

FIG. 27 is a flowchart illustrating the operation of a microscope system in the fourth embodiment;

FIG. 28 is a diagram illustrating an example of the data configuration of a VS image file in the fourth embodiment;

FIG. 29 is a diagram illustrating a main functional block of a host system according to a fifth embodiment of the invention;

FIG. 30 is a flowchart illustrating the operation of a microscope system in the fifth embodiment;

FIG. 31 is a flowchart illustrating a detail process sequence of a multi-stage pigment amount calculating process; and

FIG. 32 is a flowchart illustrating the operation of a microscope system according to a modification.

### DETAILED DESCRIPTION

Hereinafter, the preferred embodiments of the invention will be described in detail with reference to the accompanying drawings. However, the invention is not intended to be limited by the embodiments. In the drawings, the same components are denoted by the same reference numerals.

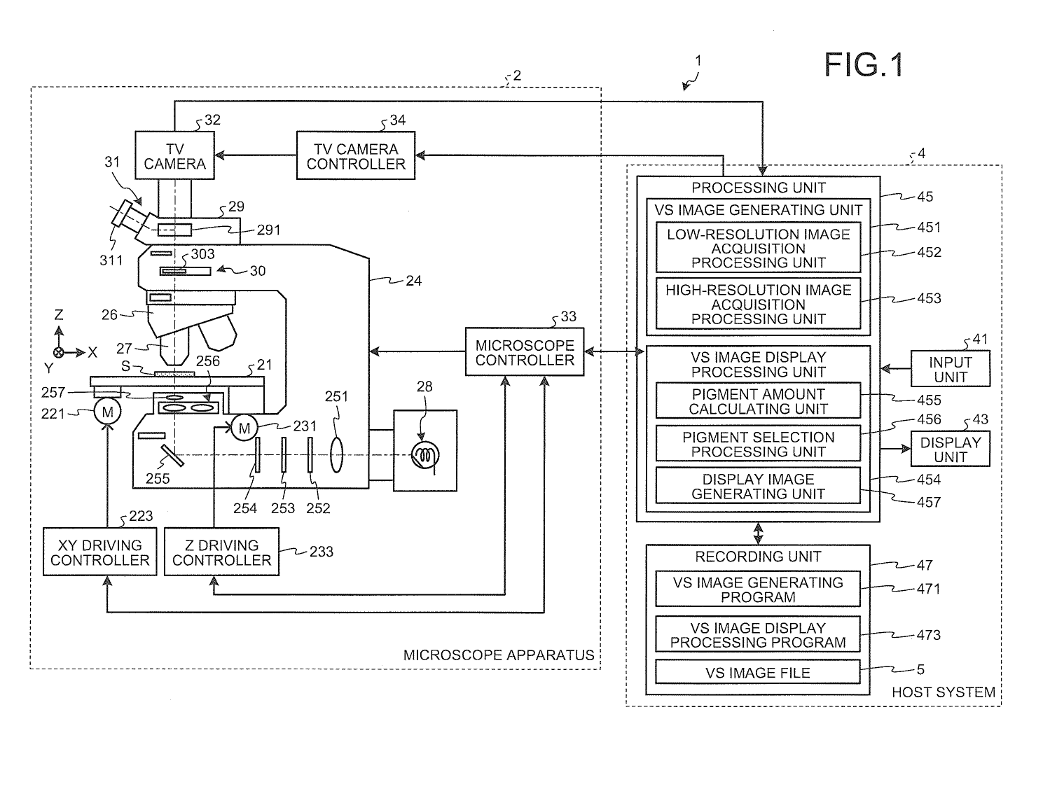

FIG. 1 schematically illustrates an example of the entire configuration of a microscope system 1 according to a first embodiment of the invention. As illustrated in FIG. 1, the microscope system 1 is configured by connecting a microscope apparatus 2 and a host system 4 to exchange data with each other. Specifically, FIG. 1 illustrates the schematic configuration of the microscope apparatus 2 and a main functional block of the host system 4. Hereinafter, an optical axis direction of an objective lens 27 illustrated in FIG. 1 is defined as a Z direction and a plane vertical to the Z direction is defined as an XY plane.

The microscope apparatus 2 includes an electromotive stage 21 where a specimen S is loaded, a microscope body 24, a light source 28 that is disposed at the back (the right side of FIG. 1) of a bottom portion of the microscope body 24, and a lens barrel 29 that is loaded on the upper portion of the microscope body 24. The microscope body 24 has an approximately U shape in side view, and supports the electromotive stage 21 and holds the objective lens 27 through a revolver 26. In the lens barrel 29, a binocular unit 31 that is used to visually observe a specimen image of the specimen S and a TV camera 32 that is used to capture the specimen image of the specimen S are mounted.

In this case, the specimen S that is loaded on the electromotive stage 21 is a multi-stained specimen that is multi-stained by a plurality of pigments. Specifically, the specimen S is subjected to morphological observation staining for a morphological observation and molecule target staining for confirming an expression of molecule information.

The morphological observation staining stains and visualizes a cell nucleus, a cytoplasm or a connective tissue. According to the morphological observation staining, sizes or positional relationships of elements constituting a tissue can be grasped, and a state of the specimen can be morphologically determined. In this case, examples of the morphological observation staining may include the HE staining, the Pap staining, and triple staining that performs special staining, such as hematoxylin staining (E staining), Giemsa staining, and Elastica-van Gieson staining, the HE staining, and Victoria Blue staining to specifically stain an elastic fiber. The Pap staining or the Giemsa staining is a staining method that is used for a specimen for cytological diagnosis.

Meanwhile, in the molecule target staining, an IHC method or an ICC method causes a specific antibody with respect to a material (mainly, protein material) needed to examine the location to act on a tissue so as to be coupled with the material, thereby visualizing a state thereof. For example, an enzyme antibody technique that visualizes location of the antibody coupled with an antigen by color formation through an enzymatic reaction is known. As an enzyme, for example, peroxidase or alkaline phosphatase is generally used.

That is, in this invention, a pigment that stains the specimen S includes a color component that is visualized by staining and a color component that is visualized by the color formation through the enzymatic reaction. Hereinafter, the pigment that is visualized by the morphological observation staining is called a “morphological observation pigment”, the pigment that is visualized by the molecule target staining is called a “molecule target pigment”, and the pigment that actually stains the specimen S is called a “staining pigment”.

In the description below, HE staining using two pigments of hematoxylin (hereinafter, referred to as “H pigment”) and eosin (hereinafter, referred to as “E pigment”) is carried out as the morphological observation staining, and a tissue specimen is labeled by color formation though a DAB reaction (hereinafter, referred to as “DAB pigment”) using an MIB-1 antibody that recognizes a Ki-67 antigen as the molecule target staining. That is, the staining pigments of the specimen S are the H pigment, the E pigment, and the DAB pigment, a cell nucleus of the specimen S is stained with a blue-purple color through the H pigment, the cytoplasm or connective tissue is stained with a pink color by the E pigment, and the Ki-67 antigen is labeled with a dark brown color by the DAB pigment. In this case, the Ki-67 antigen is a protein in a nucleus that is expressed during a growth phase of a cell cycle. The invention can also be applied to the case of observing a specimen multi-stained by the enzyme antibody technique. However, the invention is not limited to the specimen stained by the enzyme antibody technique, and may also be applied to a specimen that is labeled by the CISH method. Alternatively, the invention may also be applied to a specimen that is labeled simultaneously (multi-stained) by the IHC method and the CISH method.

The electromotive stage 21 is configured to freely move in X, Y, and Z directions. That is, the electromotive stage 21 freely moves in an XY plane by a motor 221 and an XY driving controller 223 to control driving of the motor 221. The XY driving controller 223 detects a predetermined origin position in the XY plane of the electromotive stage 21 by an origin sensor of an XY position (not illustrated), under the control of a microscope controller 33. The XY driving controller 223 controls the driving amount of the motor 221 on the basis of the origin position and moves an observation place on the specimen S. The XY driving controller 223 outputs an X position and a Y position of the electromotive stage 21 at the time of the observation to the microscope controller 33. The electromotive stage 21 freely moves in a Z direction by a motor 231 and a Z driving controller 233 to control driving of the motor 231. The Z driving controller 233 uses an origin sensor of a Z position (not illustrated) to detect a predetermined origin position in a Z direction of the electromotive stage 21, under the control of the microscope controller 33. The Z driving controller 233 controls the driving amount of the motor 231 on the basis of the origin position, and focuses and moves the specimen S to the arbitrary Z position in a predetermined height range. The Z driving controller 233 outputs a Z position of the electromotive stage 21 at the time of the observation to the microscope controller 33.

The revolver 26 is held to freely rotate with respect to the microscope body 24, and disposes the objective lens 27 on the upper portion of the specimen S. The objective lens 27 and another objective lens having a different magnification (observation magnification) are mounted to be freely exchanged, with respect to the revolver 26. The objective lens 27 that is inserted into an optical path of observation light according to the rotation of the revolver 26 and is used to observe the specimen S is configured to be alternatively switched. In the first embodiment, the revolver 26 holds at least one objective lens (hereinafter, referred to as “low-magnification objective lens) that has a relatively low magnification of, for example, 2× and 4× and at least one objective lens (hereinafter, referred to as “high-magnification objective lens”) that has a magnification higher than the magnification of the low-magnification objective lens, for example, a magnification of 10×, 20×, and 40×, as the objective lens 27. However, the above-described high and low magnifications are only exemplary, and at least one magnification may be higher than the other magnification.

The microscope body 24 incorporates an illumination optical system for transparently illuminating the specimen S in a bottom portion. The illumination optical system is configured by appropriately disposing a collector lens 251, an illumination system filter unit 252, a field stop 253, an aperture stop 254, a fold mirror 255, a capacitor optical element unit 256, and a top lens unit 257 along an optical path of illumination light. The collector lens 251 condenses illumination light that is emitted from the light source 28. The fold mirror 255 deflects the optical path of the illumination light along an optical axis of the objective lens 27. The illumination light that is emitted from the light source 28 is irradiated onto the specimen S by the illumination optical system and is incident on the objective lens 27 as objection light.

The microscope body 24 incorporates a filter unit 30 in an upper portion thereof. The filter unit 30 holds an optical filter 303, which restricts a wavelength band of light forming an image as a specimen image to a predetermined range, to freely rotate, and inserts the optical filter 303 into the optical path of the observation light in a rear stage of the objective lens 27. The observation light that passes through the objective lens 27 is incident on the lens barrel 29 after passing through the filter unit 30.

The lens barrel 29 incorporates a beam splitter 291 that switches the optical path of the observation light passed through the filter unit 30 and guides the observation light to the binocular unit 31 or the TV camera 32. The specimen image of the specimen S is introduced into the binocular unit 31 by the beam splitter 291 and is visually observed by a user using a microscope through an eyepiece lens 311. Alternatively, the specimen image of the specimen S is captured by the TV camera 32. The TV camera 32 is configured to include an imaging element, such as a CCD or a CMOS, which forms a specimen image (in detail, viewing range of the objective lens 27), and captures the specimen image and outputs image data of the specimen image to the host system 4.

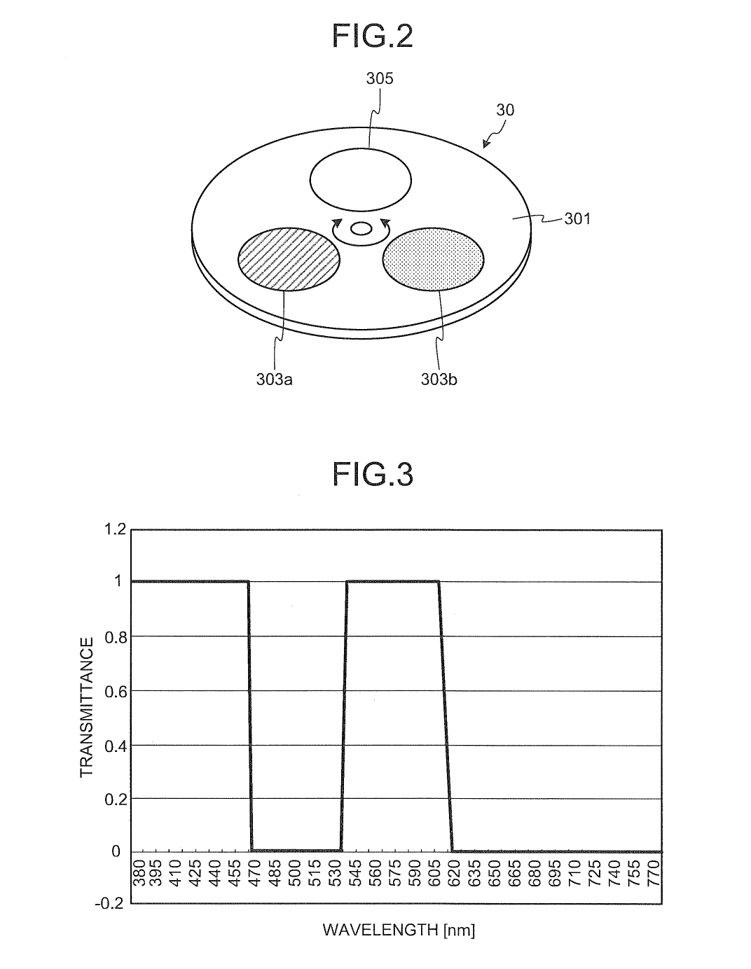

In this case, the filter unit 30 will be described in detail. The filter unit 30 is used when the specimen image is captured with multi-bands by the TV camera 32. FIG. 2 illustrates the schematic configuration of the filter unit 30. The filter unit 30 illustrated in FIG. 2 has a rotation-type optical filter switching unit 301 where three mounting holes needed to mount optical elements are formed. In the filter unit 30, two optical filters 303 (303a and 303b), each of which has a different spectral transmittance characteristic, are mounted in the two mounting holes of the three mounting holes, respectively, and the remaining one mounting hole is configured as an empty hole 305.

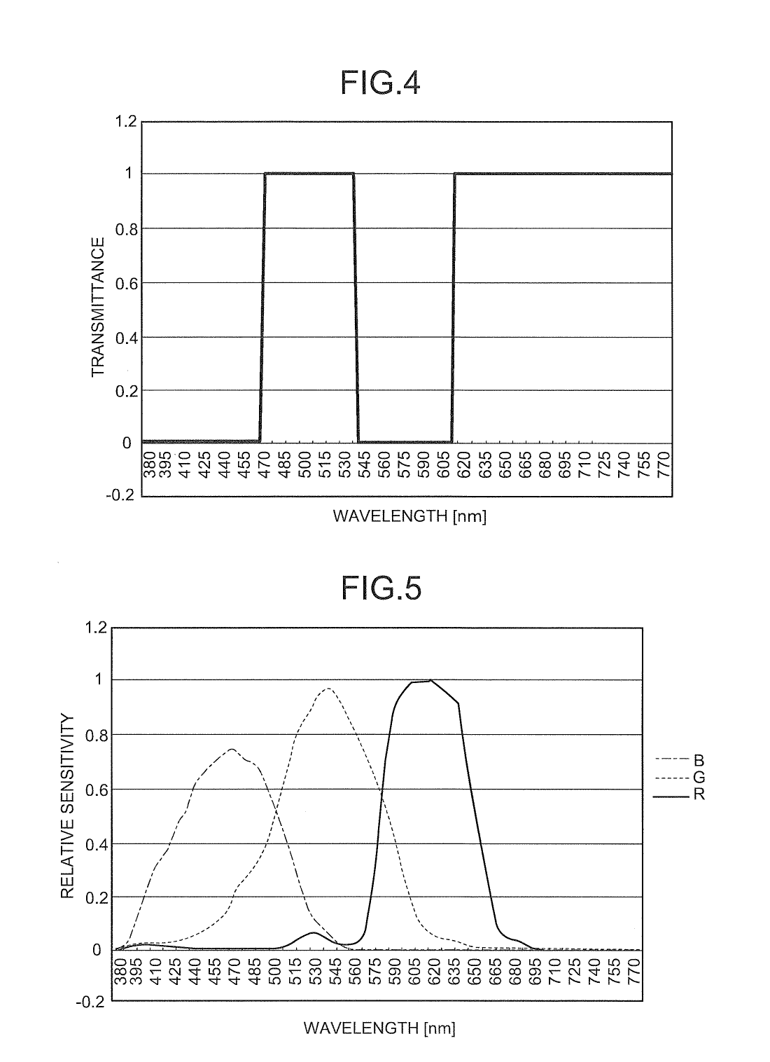

FIG. 3 illustrates a spectral transmittance characteristic of one optical filter 303a, and FIG. 4 illustrates a spectral transmittance characteristic of the other optical filter 303b. As illustrated in FIGS. 3 and 4, each of the optical filters 303a and 303b has a spectral characteristic of dividing each band for R, G, and B of the TV camera 32 into two parts. When the specimen S is captured with multi-bands, first, the optical filter switching unit 301 rotates to insert the optical filter 303a into the optical path of the observation light, and the first capturing of the specimen image is performed by the TV camera 32. Next, the optical filter switching unit 301 rotates to insert the optical filter 303b into the optical path of the observation light, and the second capturing of the specimen image is performed by the TV camera 32. By each of the first capturing and the second capturing, images of three bands are obtained, and a multi-band image of six bands is obtained by synthesizing the images of the three bands.

As such, when the specimen image is captured with the multi-bands using the filter unit 30, the illumination light that is emitted from the light source 28 and irradiated onto the specimen S by the illumination optical system is incident on the objective lens 27 as the observation light. Then, the illumination light passes through the optical filter 303a or the optical filter 303b and forms an image on the imaging element of the TV camera 32. FIG. 5 illustrates an example of spectral sensitivity of each band for R, G, and B when the specimen image is captured by the TV camera 32.

When common capturing is performed (RGB images of the specimen image are captured), the empty hole 305 may be disposed on the optical path of the observation light by rotating the optical filter switching unit 301 of FIG. 2. Here, the case where the optical filters 303a and 303b are disposed in the rear stage of the objective lens 27 is exemplified, but the invention is not limited thereto. The optical filters 303a and 303b may be disposed at any positions on the optical path that ranges from the light source 28 to the TV camera 32. The number of optical filters is not limited to two, a filter unit may be configured using three or more optical filters, and the number of bands of the multi-band image is not limited to 6. For example, using the technology that is disclosed in Japanese Unexamined Patent Application Publication No. 7-120324 descried in the related art, multi-band images may be captured according to a frame sequential method while switching 16 band-pass filters, such that a multi-band image of 16 bands is obtained. The configuration where the multi-band image is captured is not limited to the optical filter switching method. For example, plural TV cameras are arranged. Then, the observation light may be guided to each TV camera through the beam splitter, and an image forming optical system that complementarily complements a spectral characteristic may be configured. According to this configuration, the specimen images are simultaneously captured by the individual TV cameras, and a multi-band image is obtained by synthesizing the specimen images. Therefore, a high-speed process is enabled.

As illustrated in FIG. 1, the microscope apparatus 2 includes the microscope controller 33 and a TV camera controller 34. The microscope controller 33 wholly controls the operation of each unit constituting the microscope apparatus 2, under the control of the host system 4. For example, the microscope controller 33 rotates the revolver 26 to switch the objective lens 27 disposed on the optical path of the observation light, controls modulated light of the light source 28 according to the magnification of the switched objective lens 27, switches various optical elements, and instructs to move the electromotive stage 21 to the XY driving controller 223 or the Z driving controller 233. In this way, the microscope controller 33 controls each unit of the microscope apparatus 2 at the time of observing the specimen S, and notifies the host system 4 of a state of each unit. The TV camera controller 34 performs ON/OFF switching of automatic gain control, gain setting, ON/OFF switching of automatic exposure control, and exposure time setting, under the control of the host system 4, drives the TV camera 32, and controls the capturing operation of the TV camera 32.

Meanwhile, the host system 4 includes an input unit 41, a display unit 43, a processing unit 45, and a recording unit 47.

The input unit 41 is realized by a keyboard or a mouse, a touch panel, and various switches, and outputs an operation signal according to an operation input to the processing unit 45. The display unit 43 is realized by a display device, such as a LCD or an EL display, and displays various screens on the basis of display signals received from the processing unit 45.

The processing unit 45 is realized by hardware, such as a CPU. The processing unit 45 outputs an instruction to each unit constituting the host system 4 or transfers data to each unit, on the basis of an input signal received from the input unit 41, a state of each unit of the microscope apparatus 2 received from the microscope controller 33, image data received from the TV camera 32, and a program or data recorded in the recording unit 47, or outputs an operation instruction of each unit of the microscope apparatus 2 to the microscope controller 33 or the TV camera controller 34, and wholly controls the entire operation of the microscope system 1. For example, the processing unit 45 evaluates a contrast of an image at each Z position on the basis of the image data received from the TV camera 32, while moving the electromotive stage 21 in a Z direction, and executes an AF (automatic focus) process of detecting a focused focus position (focused position). The processing unit 45 executes a compressing process based on a compressing scheme such as JPEG or JPEG2000 or an extending process, when the image data received from the TV camera 32 is recorded in the recording unit 47 or displayed on the display unit 43. The processing unit 45 includes a VS image generating unit 451 and a VS image display processing unit 454 that functions as a display processing unit.

The VS image generating unit 451 acquires a low-resolution image and a high-resolution image of the specimen image and generates a VS image. In this case, the VS image is an image that is generated by synthesizing one or more images captured by the microscope apparatus 2. Hereinafter, however, the VS image means an image that is generated by synthesizing a plurality of high-resolution images obtained by capturing individual parts of the specimen S using a high-magnification objective lens, and a multi-band image having high resolution and a wide field where the entire area of the specimen S is reflected.

The VS image generating unit 451 includes a low-resolution image acquisition processing unit 452 and a high-resolution image acquisition processing unit 453 that functions as an image acquiring unit and a specimen image generating unit. The low-resolution image acquisition processing unit 452 instructs the operation of each unit of the microscope apparatus 2 and acquires a low-resolution image of the specimen image. The high-resolution image acquisition processing unit 453 instructs the operation of each unit of the microscope apparatus 2 and acquires a high-resolution image of the specimen image. In this case, the low-resolution image is acquired as an RGB image using a low-magnification objective lens, when the specimen S is observed. Meanwhile, the high-resolution image is acquired as a multi-band image using a high-magnification objective lens, when the specimen S is observed.

The VS image display processing unit 454 calculates the pigment amount of each staining pigment staining each specimen position on the specimen S, on the basis of the VS image, and displays a display image where the pigment amount of a pigment becoming a display target (display target pigment) among the staining pigments is selectively displayed on the display unit 43. The VS image display processing unit 454 includes a pigment amount calculating unit 455 that functions as a pigment amount acquiring unit, a pigment selection processing unit 456 that functions as a pigment selecting unit and a pigment selection requesting unit, and a display image generating unit 457. The pigment amount calculating unit 455 estimates spectral transmittance at each specimen position on the specimen S corresponding to each pixel constituting the VS image, and calculates the pigment amount of each staining pigment at each specimen position, on the basis of the estimated spectral transmittance (estimation spectrum). The pigment selection processing unit 456 receives a selection operation of a display target pigment from a user through the input unit 41, and selects the display target pigment according to the operation input. The display image generating unit 457 generates a display image where a staining state by the display target pigment is displayed, on the basis of the pigment amount of the display target pigment.

The recording unit 47 is realized by various IC memories such as a ROM or a RAM like a flash memory enabling update and storage, a hard disk to be incorporated or connected by a data communication terminal, and a storage medium such as a CD-ROM and a reading device thereof. In the recording unit 47, a program that causes the host system 4 to operate and realizes various functions included in the host system 4 or data that is used during the execution of the program is recorded.

In the recording unit 47, a VS image generating program 471 that causes the processing unit 45 to function as the VS image generating unit 451 and realizes a VS image generating process is recorded. In the recording unit 47, a VS image display processing program 473 that causes the processing unit 45 to function as the VS image display processing unit 454 and realizes the VS image display process is recorded. In the recording unit 47, a VS image file 5 is recorded. In the VS image file 5, image data of a low-resolution image or a high-resolution image of the specimen image and data of the pigment amount at each specimen position are recorded together with identification information of the specimen S or staining information of the specimen S. The VS image file 5 will be described in detail below.

The host system 4 can be realized by the known hardware configuration including a CPU or a video board, a main storage device such as a main memory (RAM), an external storage device such as a hard disk or various storage medium, a communication device, an output device such as a display device or a printing device, an input device, and an interface device connecting each component or an external input. For example, as the host system 4, a general-purpose computer, such as a workstation or a personal computer, may be used.

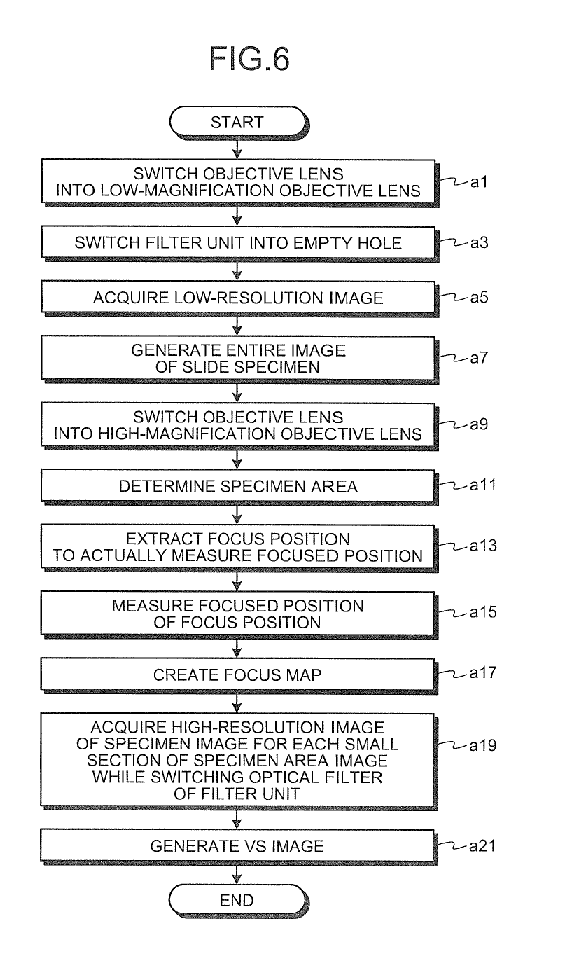

Next, the VS image generating process and the VS image display process according to the first embodiment will be sequentially described. First, the VS image generating process will be described. FIG. 6 is a flowchart illustrating the operation of the microscope system 1 that is realized when the processing unit 45 of the host system 4 executes the VS image generating process. The operation of the microscope system 1 described herein is realized when the VS image generating unit 451 reads the VS image generating program 471 recorded in the recording unit 47 and executes the VS image generating program 471.

First, the low-resolution image acquisition processing unit 452 of the VS image generating unit 451 outputs an instruction, which causes the objective lens 27 used when the specimen S is observed to be switched into the low-magnification objective lens, to the microscope controller 33 (Step a1). In response to the instruction, the microscope controller 33 rotates the revolver 26 according to necessity and disposes the low-magnification objective lens on the optical path of the observation light.

Next, the low-resolution image acquisition processing unit 452 outputs an instruction, which causes the filter unit 30 to be switched into the empty hole 305, to the microscope controller 33 (Step a3). In response to the instruction, the microscope controller 33 rotates the optical filter switching unit 301 of the filter unit 30 according to necessity and disposes the empty hole 305 on the optical path of the observation light.

Next, the low-resolution image acquisition processing unit 452 outputs an operation instruction of each unit of the microscope apparatus 2 to the microscope controller 33 or the TV camera controller 34, and acquires a low-resolution image (RGB image) of the specimen image (Step a5).

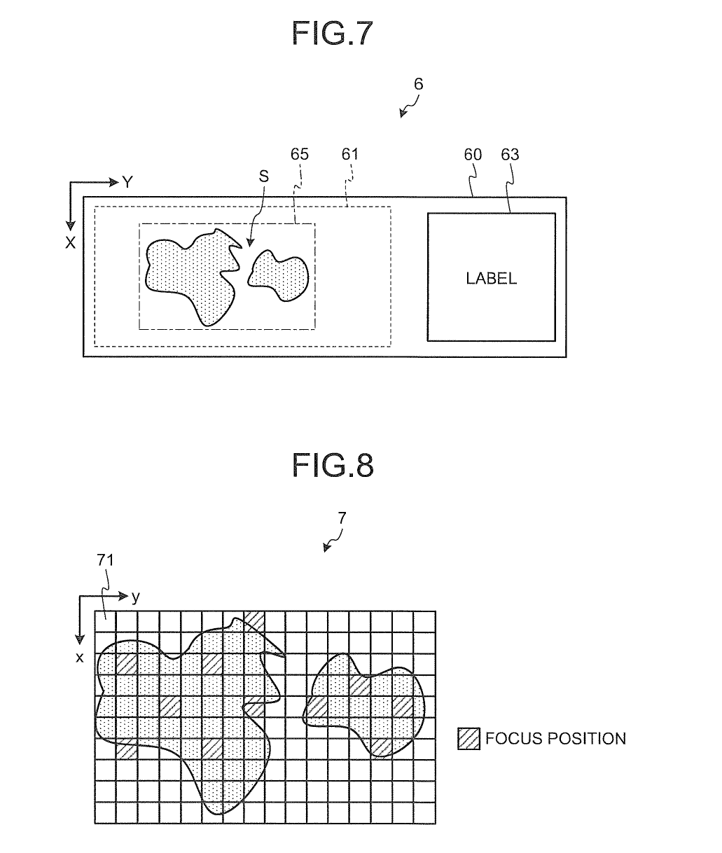

FIG. 7 illustrates an example of a slide glass specimen 6. The specimen S on the electromotive stage 21 illustrated in FIG. 1 is actually loaded on the electromotive stage 21 as the slide glass specimen 6 where the specimen S is loaded on a slide glass 60, as illustrated in FIG. 7. The specimen S is controlled to be loaded in a specimen search range 61 corresponding to a predetermined area (for example, area of the vertical length: 25 mm×the horizontal length: 50 mm of the left side of the slide glass 60 in FIG. 7) on the slide glass 60. In the slide glass 60, a label 63 where information of the specimen S loaded in the specimen search range 61 is described is attached to a predetermined area (for example, right area of the specimen search range 61). In the label 63, a barcode where a slide specimen number corresponding to identification information to specify the specimen S is coded according to the predetermined standard is printed, and is read by a barcode reader (not illustrated) that constitutes the microscope system 1.

In response to the operation instruction by the low-resolution image acquisition processing unit 452 in step a5 of FIG. 6, the microscope apparatus 2 captures an image of the specimen search range 61 of the slide glass 60 illustrated in FIG. 7. Specifically, the microscope apparatus 2 divides the specimen search range 61 on the basis of a size of a field range determined according to the magnification of the low-magnification objective lens switched in step a1 (that is, capturing range of the TV camera 32 of when the specimen S is observed using the low-magnification objective lens), and sequentially captures the specimen image of the specimen search range 61 with the TV camera 32 for each section, while moving the electromotive stage 21 in an XY plane according to each divided section size. In this case, the captured image data is output to the host system 4 and acquired as a low-resolution image of the specimen image in the low-resolution image acquisition processing unit 452.

As illustrated in FIG. 6, the low-resolution image acquisition processing unit 452 synthesizes the low-resolution images for the individual sections acquired in step a5, and generates an image where the specimen search range 61 of FIG. 7 is reflected as an entire image of the slide specimen (Step a7).

Next, the high-resolution image acquisition processing unit 453 outputs an instruction, which causes the objective lens 27 used when the specimen S is observed to be switched into the high-magnification objective lens, to the microscope controller 33 (Step a9). In response to the instruction, the microscope controller 33 rotates the revolver 26 and disposes the high-magnification objective lens on the optical path of the observation light.

Next, the high-resolution image acquisition processing unit 453 automatically extracts and determines a specimen area 65 in the specimen search range 61 of FIG. 7 where the specimen S is actually loaded, on the basis of the entire image of the slide specimen generated in step a7 (Step a11). The automatic extraction of the specimen area can be performed by appropriately using the known methods. For example, the high-resolution image acquisition processing unit 453 digitizes a value of each pixel of the entire image of the slide specimen, determines existence or non-existence of the specimen S for each pixel, and determines a rectangular area, which surrounds a range of pixels determined as the pixels reflecting the specimen S, as the specimen area. The high-resolution image acquisition processing unit 453 may receive the selection operation of the specimen area from the user through the input unit 41, and determine the specimen area according to the operation input.

Next, the high-resolution image acquisition processing unit 453 cuts out the image of the specimen area (specimen area image) determined in step a11 from the entire image of the slide specimen, selects a position to actually measure a focused position from the specimen area image, and extracts a focus position (Step a13).

FIG. 8 illustrates an example of a specimen area image 7 that is cut from the entire image of the slide specimen, which specifically illustrates an image of the specimen area 65 of FIG. 7. As illustrated in FIG. 8, first, the high-resolution image acquisition processing unit 453 divides the specimen area image 7 into a lattice shape and forms a plurality of small sections. In this case, a size of each small section corresponds to a size of a field range (that is, capturing range of the TV camera 32 of when the specimen S is observed using the high-magnification objective lens) that is determined according to the magnification of the high-magnification objective lens switched in step a9.

Next, the high-resolution image acquisition processing unit 453 selects the small sections becoming the focus positions from the plurality of formed small sections, because a process time may increase, if a focused position is actually measured with respect to all of the small sections. For example, the small sections of the predetermined number are randomly selected from the small sections. Alternatively, the small sections becoming the focus positions may be selected from the small sections at intervals of the predetermined number of small sections, that is, the small sections may be selected according to the predetermined rule. When the number of small sections is small, all of the small sections may be selected as the focus positions. The high-resolution image acquisition processing unit 453 calculates the central coordinates of the small section selected in a coordinate system (x, y) of the specimen area image 7, converts the calculated central coordinates into the coordinates of a coordinate system (X, Y) of the electromotive stage 21 of the microscope apparatus 2, and obtains the focus positions. The coordinate conversion is performed on the basis of the magnification of the objective lens 27 used when the specimen S is observed or the number or sizes of pixels of imaging elements constituting the TV camera 32, and can be realized by applying the known technology disclosed in Japanese Unexamined Patent Application Publication No. 9-281405.

Next, as illustrated in FIG. 6, the high-resolution image acquisition processing unit 453 outputs an operation instruction of each unit of the microscope apparatus 2 to the microscope controller 33 or the TV camera controller 34, and measures the focused position of the focus position (Step a15). At this time, the high-resolution image acquisition processing unit 453 outputs each extracted focus position to the microscope controller 33. In response to the output, the microscope apparatus 2 moves the electromotive stage 21 in the XY plane and sequentially moves each focus position to the optical axis position of the objective lens 27. The microscope apparatus 2 receives image data of each focus position by the TV camera 32 while moving the electromotive stage 21 in a Z direction at each focus position. The received image data is output to the host system 4 and acquired in the high-resolution image acquisition processing unit 453. The high-resolution image acquisition processing unit 453 evaluates a contrast of image data at each Z position and measures a focused position (Z position) of the specimen S at each focus position.

In this way, if the high-resolution image acquisition processing unit 453 measures the focused position at each focus position, the high-resolution image acquisition processing unit 453 creates a focus map on the basis of the measurement result of the focused position of each focus position, and records the focus map in the recording unit 47 (Step a17). Specifically, the high-resolution image acquisition processing unit 453 interpolates the focused position of the small section not extracted as the focus position in step a13 with the focused position of the surrounding focus position, sets the focused positions to all of the small sections, and creates the focus map.

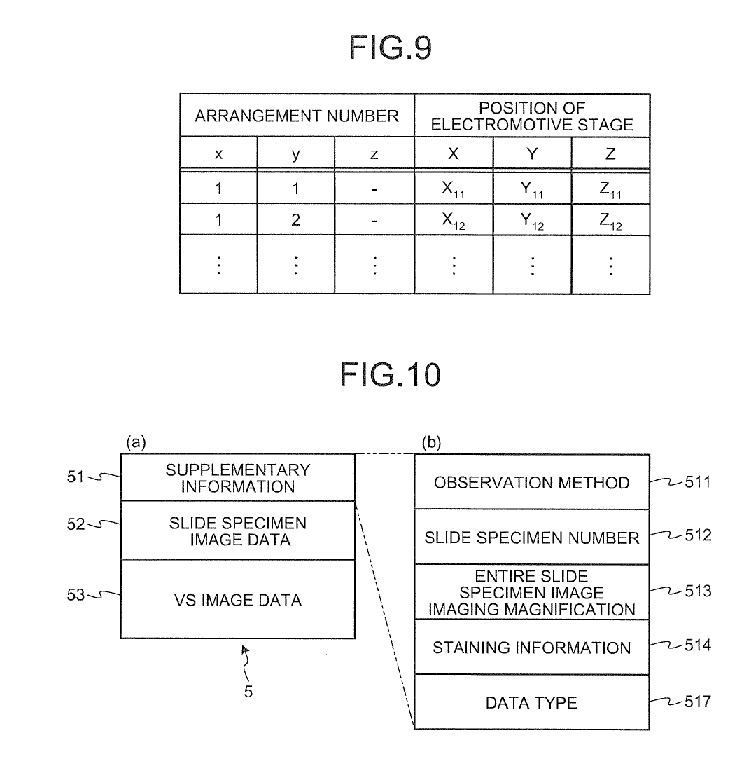

FIG. 9 illustrates an example of the data configuration of a focus map. As illustrated in FIG. 9, the focus map is a data table where arrangement numbers and electromotive stage positions are associated with each other. The arrangement numbers indicate the individual small sections of the specimen area image 7 illustrated in FIG. 8, respectively. Specifically, the arrangement numbers indicated by x are serial numbers that are sequentially assigned to individual columns along an x direction starting from a left end, and the arrangement numbers indicated by y are serial numbers that are sequentially assigned to individual rows along a y direction starting from an uppermost stage. The arrangement numbers indicated by z are values that are set when the VS image is generated as a three-dimensional image. The electromotive stage positions are positions of X, Y, and Z of the electromotive stage 21 set as the focused positions with respect to the small sections of the specimen area image indicated by the corresponding arrangement numbers. For example, the arrangement number of (x, y, z)=(1, 1, −) indicates a small section 71 of FIG. 8, and a Z position and a Y position of when the central coordinates of the small section 71 in the coordinate system (x, y) are converted into the coordinates of the coordinate system (X, Y) of the electromotive stage 21 correspond to X₁₁ and Y₁₁, respectively. The focused position (Z position) that is set to the small section corresponds to Z₁₁.

Next, as illustrated in FIG. 6, the high-resolution image acquisition processing unit 453 sequentially output instructions, which cause the filter unit 30 to be switched into the optical filters 303a and 303b, to the microscope controller 33, outputs an operation instruction of each unit of the microscope apparatus 2 to the microscope controller 33 or the TV camera controller 34 while referring to the focus map, captures the specimen image with multi-bands for each small section of the specimen area image, and acquires a high-resolution image (hereinafter, referred to as “specimen area section image”) (Step a19).

In response to this, the microscope apparatus 2 rotates the optical filter switching unit 301 of the filter unit 30, and sequentially captures a specimen image for each small section of the specimen area image with the TV camera 32 at each focused position, while moving the electromotive stage 21 in a state where the optical filter 303a is first disposed on the optical path of the observation light. Next, the optical filter 303a is switched into the optical filter 303b, the optical filter 303b is disposed on the optical path of the observation light, and the specimen image for each small section of the specimen area image is captured, similar to the above case. In this case, the captured image data is output to the host system 4 and acquired as a high-resolution image (specimen area section image) of the specimen image in the high-resolution image acquisition processing unit 453.

Next, the high-resolution image acquisition processing unit 453 synthesizes the specimen area section images that correspond to the high-resolution images acquired in step a19, and generates one image where the entire area of the specimen area 65 of FIG. 7 is reflected as a VS image (Step a21).

In the steps a13 to a21, the specimen area image is divided into the small sections that correspond to the field range of the high-magnification objective lens. The specimen images are captured for the individual small sections to acquire the specimen area section images, and the specimen area section images are synthesized with each other to generate the VS image. Meanwhile, the small sections may be set such that the surrounding specimen area section images partially overlap each other at the surrounding positions. The specimen area section images may be bonded to each other according to the positional relationship between the surrounding specimen area section images and synthesized with each other, and one VS image may be generated. The specific process can be realized by applying the known technology disclosed in Japanese Unexamined Patent Application Publication No. 9-281405 or 2006-343573. In this case, the section size of the small sections is set to a size smaller than the field range of the high-magnification objective lens, such that end portions of the acquired specimen area section images overlap the surrounding specimen area section images. In this way, even when movement control precision of the electromotive stage 21 is low and the surrounding specimen area section images become discontinuous, a natural VS image where a joint is continuous by the overlapping portions can be generated.

As the result of the VS image generating process described above, a multi-band image having high resolution and a wide field where the entire area of the specimen S is reflected is obtained. In this case, the processes of steps a1 to a21 are automatically executed. For this reason, the user may load the specimen S (in detail, slide glass specimen 6 of FIG. 7) on the electromotive stage 21, and input a start instruction of the VS image generating process through the input unit 41. The process of each of the steps a1 to a21 may be appropriately stopped, and the user may perform the operation. For example, a process of switching the used high-magnification objective lens into an objective lens having a different magnification according to the operation input after step a9, a process of modifying the determined specimen area according to the operation input after step a11, and a process of changing, adding or deleting the extracted focus position according to the operation input after step a13 may be appropriately executed.

FIGS. 10 to 12 illustrate an example of the data configuration of the VS image file 5 that is obtained as the result of the VS image generating process and recorded in the recording unit 47. As illustrated in (a) in FIG. 10, the VS image file 5 includes supplementary information 51, entire slide specimen image data 52, and VS image data 53.

As illustrated in (b) in FIG. 10, in the supplementary information 51, an observation method 511 or a slide specimen number 512, an entire slide specimen image imaging magnification 513, staining information 514, and a data type 517 are set.

The observation method 511 is an observation method of the microscope apparatus 2 that is used to generate the VS image. In the first embodiment, a “bright field observation method” is set. When a microscope apparatus that enables an observation of a specimen using another observation method, such as a dark field observation method, a fluorescent observation method, or a differential interference observation method, is used, an observation method of when the VS image is generated is set.

In the slide specimen number 512, a slide specimen number that is read from the label 63 of the slide glass specimen 6 illustrated in FIG. 7 is set. The slide specimen number is an ID that is uniquely allocated to the slide glass specimen 6, and the specimen S can be individually identified using the ID. In the entire slide specimen image imaging magnification 513, the magnification of the low-magnification objective lens that is used at the time of acquiring the entire slide specimen image is set. The entire slide specimen image data 52 is image data of the entire slide specimen image.

In the staining information 514, a staining pigment of the specimen S is set. That is, in the first embodiment, the H pigment, the E pigment, and the DAB pigment are set. However, the staining information 514 is set when the user inputs the pigment staining the specimen S and registers the pigment, in the course of the VS image display process to be described in detail below.

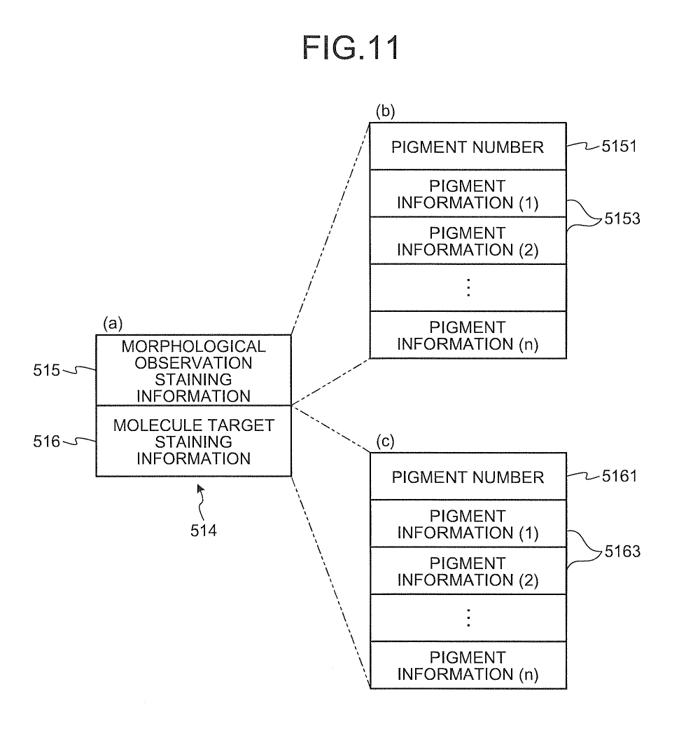

Specifically, as illustrated in (a) in FIG. 11, the staining information 514 includes morphological observation staining information 515 where a morphological observation pigment among the staining pigments is set, and molecule target staining information 516 where a molecule target pigment is set.

As illustrated in (b) in FIG. 11, the morphological observation staining information 515 includes a pigment number 5151, and pigment information (1) to (n) 5153 of the number that corresponds to the pigment number 5151. In the pigment number 5151, the number of morphological observation pigments staining the specimen S is set. In the pigment information (1) to (n) 5153, pigment names of the morphological observation pigments are set, respectively. In the first embodiment, “2” is set as the pigment number 5151 and the “H pigment” and the “E pigment” are set as the two pigment information 5153. The molecule target staining information 516 is configured in the same way as the morphological observation staining information 515. As illustrated in (c) in FIG. 11, the molecule target staining information 516 includes a pigment number 5161, and pigment information (1) to (n) 5163 of the number that corresponds to the pigment number 5161. In the pigment number 5161, the number of molecule target pigments staining the specimen S is set. In the pigment information (1) to (n) 5163, pigment names of the molecule target pigments are set, respectively. In the first embodiment, “1” is set as the pigment number 5161 and the “DAB pigment” is set as one pigment information 5163.

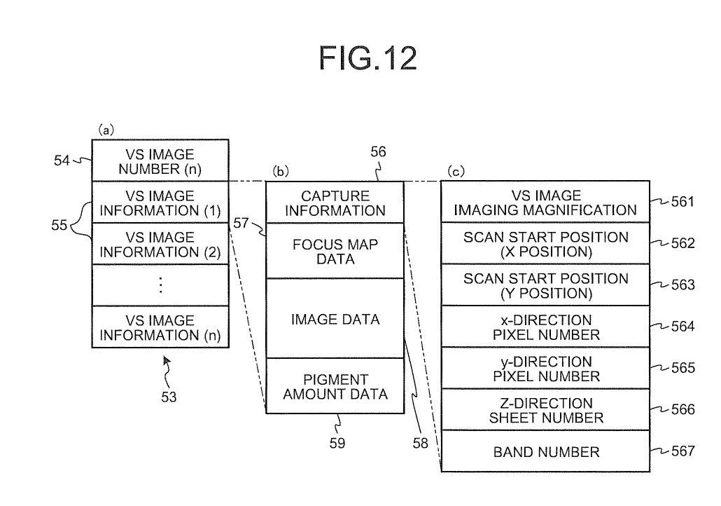

The data type 517 of (b) in FIG. 10 indicates a data type of the VS image. For example, the data type 517 is used to determine whether only image data (raw data) of the VS image is recorded as image data 58 (refer to (b) in FIG. 12) or the pigment amount is calculated with respect to each pixel and recorded as pigment amount data 59 (refer to (b) in FIG. 12), for example, in the VS image data 53. For example, when the VS image generating process is executed, the raw data is only recorded as the image data 58. Therefore, in the data type 517, identification information indicating the raw data is set. When the VS image display process to be described in detail below is executed, the pigment amount of each pigment in each pixel of the VS image is calculated and recorded as the pigment amount data 59. At this time, the data type 517 is updated by identification information indicating the pigment amount data.

In the VS image data 53, a variety of information that is related to the VS image is set. That is, as illustrated in (a) in FIG. 12, the VS image data 53 includes a VS image number 54 and VS image information (1) to (n) 55 of the number that corresponds to the VS image number 54. In this case, the VS image number 54 that is the number of VS image information 55 recorded in the VS image data 53 corresponds to n. In the example of the data configuration of the VS image data 53 illustrated in (a) in FIG. 12, the case where a plurality of VS images are generated with respect to one specimen is assumed. In the example illustrated in FIG. 7, the case where one specimen area 65 is extracted as the area where the specimen S is actually loaded in the slide glass specimen 6 has been described. However, in the slide specimen that becomes the observation target in the microscope system 1, a plurality of specimens may be distant from each other and scattered. In this case, a VS image of an area where there is no specimen does not need to be generated. For this reason, when the plurality of specimens are distant from each other to some degree and scattered, areas of the scattered specimens are individually extracted, and a VS image is generated for each of the areas of the extracted specimens. At this time, however, the number of VS images generated is set as the VS image number 54. A variety of information that is related to the individual VS images is set as the VS image information (1) to (n) 55, respectively. Even in the example of FIG. 7, areas of two specimens are included in the specimen area 65. However, since the positions of the areas of the two specimens are close to each other, the areas are extracted as one specimen area 65. In each VS image information 55, capture information 56, focus map data 57, the image data 58, and the pigment amount data 59 are set, as illustrated in (b) in FIG. 12.

In the capture information 56, a VS image imaging magnification 561, a scan start position (X position) 562, a scan start position (Y position) 563, an x-direction pixel number 564, a y-direction pixel number 565, a Z-direction sheet number 566, and a band number 567 are set, as illustrated in (c) in FIG. 12.

In the VS image imaging magnification 561, the magnification of the high-magnification objective lens that is used when the VS image is acquired is set. The scan start position (X position) 562, the scan start position (Y position) 563, the x-direction pixel number 564, and the y-direction pixel number 565 indicate a capture range of the VS image. That is, the scan start position (X position) 562 is an X position of a scan start position of the electromotive stage 21 when starting to capture each specimen area section image constituting the VS image, and the scan start position (Y position) 563 is a Y position of the scan start position. The x-direction pixel number 564 is the number of pixels of the VS image in an x direction, and the y-direction pixel number 565 is the number of pixels of the VS image in a y direction, which indicates a size of the VS image.

The Z-direction sheet number 566 corresponds to the number of sections in a Z direction, and in the first embodiment, “1” is set. When the VS image is generated as a three-dimensional image, a captured sheet number in the Z direction is set. The VS image is generated as a multi-band image. The number of bands is set to the band number 567, and in the first embodiment, “6” is set.

The focus map data 57 of (b) in FIG. 12 is the data of the focus map illustrated in FIG. 9. The image data 58 is image data of the VS image. For example, in the image data 58, raw data of 6 bands is set when the VS image generating process is executed. In the pigment amount data 59, data of the pigment amount of each staining pigment calculated for each pixel in the course of the VS image display process to be descried in detail below is set.

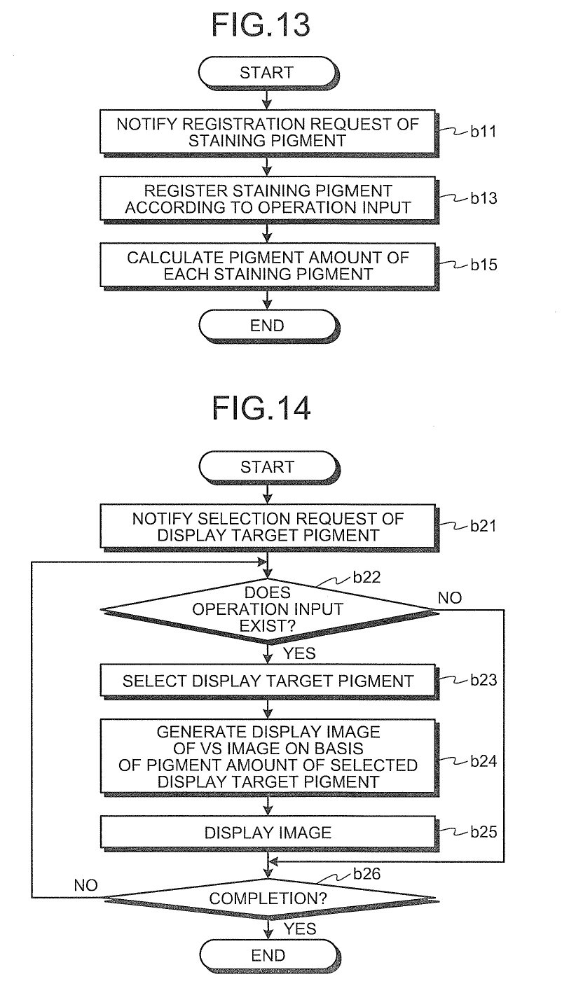

Next, the VS image display process will be described. In this case, in the VS image display process according to the first embodiment, a process of calculating the pigment amount for each pixel (pigment amount calculating process) and a process of displaying a VS image (VS image display process) using the pigment amount calculated as the result of the pigment amount calculating process are executed. FIG. 13 is a flowchart illustrating a process sequence of a pigment amount calculating process. FIG. 14 is a flowchart illustrating a process sequence of a VS image display process. Each process that is described with reference to FIGS. 13 and 14 is realized when the VS image display processing unit 454 reads the VS image display processing program 473 recorded in the recording unit 47 and executes the VS image display processing program 473.

As illustrated in FIG. 13, in the pigment amount calculating process, first, the pigment amount calculating unit 455 of the VS image display processing unit 454 executes a process of displaying a notification of a registration request of a staining pigment staining the specimen S on the display unit 43 (Step b11). Next, the pigment amount calculating unit 455 sets a pigment input by the user in response to the notification of the registration request as a staining pigment, sets the staining pigment as the staining information 514 (refer to (b) in FIG. 10) in the VS image file 5, and registers the staining pigment therein (Step b13). That is, in the first embodiment, the H pigment, the E pigment, and the DAB pigment are registered as the staining pigments.

The pigment amount calculating unit 455 calculates the pigment amount at each specimen position on the specimen S for each staining pigment, on the basis of a pixel value of each pixel of the generated VS image (Step b15). The calculation of the pigment amount can be realized by applying the known technology disclosed in Japanese Unexamined Patent Application Publication No. 2008-51654.

The process sequence will be simply described. First, the pigment amount calculating unit 455 estimates a spectrum (estimation spectrum) at each specimen position on the specimen S for each pixel, on the basis of the pixel value of the VS image. As a method of estimating a spectrum from a multi-band image, for example, Wiener estimation may be used. Next, the pigment amount calculating unit 455 estimates (calculates) the pigment amount of the specimen S for each pixel, by using a reference pigment spectrum of a calculation target pigment (staining pigment) that is measured in advance and recorded in the recording unit 47.

In this case, the calculation of the pigment amount will be simply described. In general, in a material that transmits light, between intensity I₀(λ) of incident light and intensity I(λ) of emitted light for every wavelength λ, a rule of Lambert-Beer represented by the following Equation 1 is realized.

$$\frac{I ( λ )}{{I}_{0} ( λ )} = {e}^{- k ( λ ) \cdot d} \qquad ( 1 )$$

In this case, k(λ) indicates a unique value of a material that is determined depending on a wavelength, and d indicates the thickness of the material. The left side of Equation 1 means spectral transmittance t(λ).

For example, when the specimen is stained by pigments of n kinds including a pigment 1, a pigment 2, . . . , and a pigment n, in each wavelength λ, the following equation 2 is realized by the rule of Lambert-Beer.

$$\frac{I ( λ )}{{I}_{0} ( λ )} = {e}^{- ( {k}_{1} ( λ ) \cdot {d}_{1} + {k}_{2} ( λ ) \cdot {d}_{2} + … + {k}_{n} ( λ ) \cdot {d}_{n} )} \qquad ( 2 )$$

In this case, k₁(λ), k₂(λ), . . . and kₙ(λ) indicate k(λ) that correspond to the pigment 1, the pigment 2, . . . , and the pigment n, respectively, and are, for example, reference pigment spectrums of the pigments that stain the specimen, respectively. Further, d₁, d₂, . . . and dₙ indicate virtual thicknesses of the pigment 1, the pigment 2, . . . , and the pigment n at the specimen positions on the specimen S that correspond to the individual image positions of the multi-band image, respectively. Since the pigment originally exists to be dispersed in the specimen, the concept of the thickness is not accurate. However, as compared with the case of when it is assumed that the specimen is stained by a single pigment, the thickness becomes an index of the relative pigment amount that indicates the amount by which the pigment exists. That is, d₁, d₂, . . . and dₙ indicate the pigment amounts of the pigment 1, the pigment 2, . . . , and the pigment n, respectively. Further, k₁(λ), k₂(λ), . . . and kₙ(λ) can be easily calculated from the rule of Lambert-Beer by preparing the specimens individually stained using the individual pigments of the pigment 1, the pigment 2, . . . , and the pigment n and measuring spectral transmittance thereof using a spectroscope.

If a logarithm of both sides of Equation 2 is taken, the following Equation 3 is obtained.

$$- log \frac{I ( λ )}{{I}_{0} ( λ )} = {k}_{1} ( λ ) \cdot {d}_{1} + {k}_{2} ( λ ) \cdot {d}_{2} + … + {k}_{n} ( λ ) \cdot {d}_{n} \qquad ( 3 )$$

In the above-described way, if an element corresponding to the wavelength λ of the estimation spectrum estimated for each pixel of the VS image is defined as \hat{t}(x, λ) and is substituted for Equation 3, the following Equation 4 is obtained.

−log \hat{t}(x,λ)=k₁(λ)·d₁+k₂(λ)·d₂+ . . . +kₙ(λ)·dₙ (4)

In Equation 4, since n unknown variables that include d₁, d₂, . . . and dₙ exist, Equation 4 can be solved simultaneously with respect to at least n different wavelengths λ. In order to improve precision, a multiple regression analysis may be performed by simultaneously setting Equation 4 with respect to at least n different wavelengths λ.

The simple process sequence of the pigment amount calculating process has been described. However, in the first embodiment, the staining pigments that become the calculation targets are the H pigment, the E pigment, and the DAB pigment, and the condition n=3 is satisfied. The pigment amount calculating unit 455 estimates the individual pigment amounts of the H pigment, the E pigment, and the DAB pigment that are fixed to the individual specimen positions, on the basis of the estimation spectrums estimated with respect to the individual pixels of the VS image.

Meanwhile, in the VS image display process, as illustrated in FIG. 14, first, the pigment selection processing unit 456 executes a process of displaying a notification of a selection request of a display target pigment on the display unit 43 (Step b21). Next, if an operation input that responds to the notification of the selection request is not given (Step b22: No), the pigment selection processing unit 456 proceeds to step b26. Meanwhile, when the user inputs the pigment (Step b22: Yes), the pigment selection processing unit 456 selects the corresponding pigment as the display target pigment (Step b23).

Next, the display image generating unit 457 refers to the VS image file 5, and generates a display image of the VS image on the basis of the pigment amount of the selected display target pigment (Step b24). Specifically, the display image generating unit 457 calculates a RGB value of each pixel on the basis of the pigment amount of the display target pigment in each pixel, and generates the corresponding image as the display image of the VS image. In this case, the process of converting the pigment amount into the RGB value can be realized by applying the known technology disclosed in Japanese Unexamined Patent Application Publication No. 2008-51654.

The process sequence will be simply described. First, if the pigment amounts d₁, d₂, . . . and dₙ calculated in step b15 are multiplied by selection coefficients α₁, α₂, and αₙ, respectively, and the calculated result is substituted for Equation 2, the following Equation 5 is obtained. If the selection coefficient αₙ by which the display target pigment is multiplied is set as 1 and the selection coefficient αₙ by which the non-display target pigment is multiplied is set as 0, the spectral transmittance t*(x, λ) that considers only the pigment amount of the selected display target pigment is obtained.

t*(x,λ)=e^{-(k}^{₁}^{(λ)·α}^{₁}^{d}^{₁}^{+k}^{₂}^{(λ)·α}^{₂}^{d}^{₂}^{+ . . . +k}^{ₙ}^{(λ)·αnd}^{ₙ}⁾ (5)

With respect to an arbitrary point (pixel) x of the captured multi-band image, between a pixel value g (x, b) at a band b and the spectral transmittance t(x, λ) of a corresponding point on the specimen, a relationship of the following Equation 6 based on a response system of a camera is realized.

g(x,b)=∫f(b,λ)s(λ)e(λ)t(x,λ)dλ+n(b) (6)

In this case, λ indicates a wavelength, f(b, λ) indicates spectral transmittance of a b-th filter, s(λ) indicates a spectral sensitivity characteristic of the camera, e(λ) indicates a spectral radiation characteristic of illumination, and n(b) indicates an observation noise at the band b. In addition, b is a serial number used to identify a band. In this case, b is an integer that satisfies the condition 1<b<6.

Accordingly, if Equation 5 is substituted for Equation 6 and a pixel value is calculated according to the following Equation 7, a pixel value g*(x, b) of a display image where the pigment amount of the selected display target pigment is displayed (display image where a staining state by the display target pigment is displayed) can be calculated. In this case, the observation noise n(b) may be calculated as zero.

g*(x,b)=∫f(b,λ)s(λ)e(λ)t*(x,λ)dλ (7)

Next, the VS image display processing unit 454 executes a process of displaying the generated display image on the display unit 43 (Step b25). Next, the VS image display processing unit 454 proceeds to step b26 and performs a completion determination of the VS image display process. When it is determined that the VS image display process is completed (Step b26: Yes), the VS image display processing unit 454 completes the corresponding process. Meanwhile, when it is determined that the VS image display process is not completed (Step b26: No), the VS image display processing unit 454 is returned to step b22 and receives an operation input.

The pigment amount calculating process may be executed once before the VS image display process is executed. Meanwhile, the VS image display process is executed whenever the VS image is displayed.

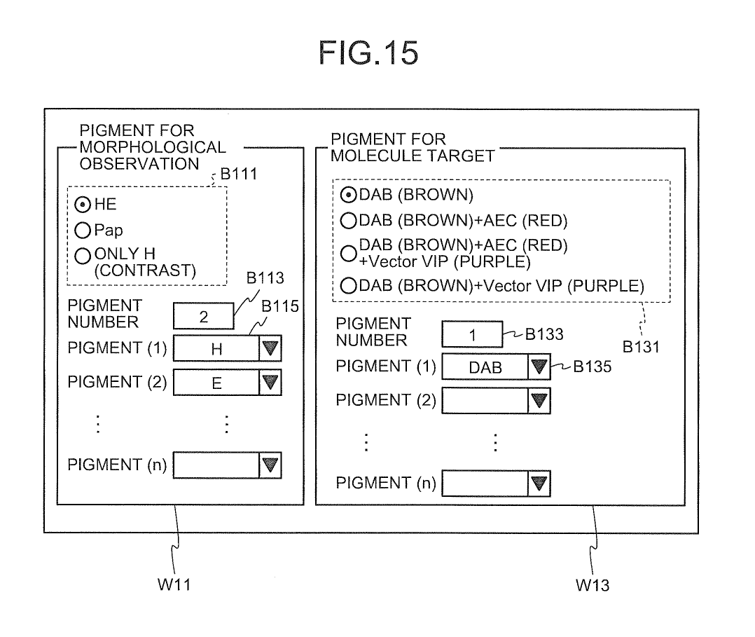

Next, an operation example of when the VS image is observed will be described. First, a registration operation of a staining pigment that is performed before the observation of the VS image will be described. FIG. 15 illustrates an example of a pigment registration screen used to notify a registration request of a staining pigment of the specimen S. As illustrated in FIG. 15, the pigment registration screen includes two screens of a morphological observation registration screen W11 and a molecule target registration screen W13.

In the morphological observation registration screen W11, an input box B113 that is used to input the number of morphological observation pigments and a plurality of spin boxes B115 that are used to select the morphological observation pigments are disposed. Each of the spin boxes B115 provides a list of pigment names as a choice and urges the selection. The provided pigments are not particularly exemplified, but appropriately include pigments known in morphological observation staining. The user operates the input unit 41 to input the number of morphological observation pigments actually staining the specimen S in the input box B113, selects the pigment names in the spin boxes B115, and registers the staining pigments. When the number of morphological observation pigments is two or more, the pigment names thereof are selected by the spin boxes B115, respectively.

The morphological observation registration screen W11 includes a standardized staining selecting unit B111. In the standardized staining selecting unit B111, the pigment (HE) that is used in the representative HE staining as the morphological observation staining, the pigment (Pap) that is used in the Pap staining, and the pigment (only H) that is used in the H staining are individually provided as the choices. The choices that are provided by the standardized staining selecting unit B111 are not limited to the exemplified choices, and may be selected by the user. In this case, with respect to the provided pigments, the pigments can be registered by checking corresponding items, and a registration operation can be simplified. For example, as illustrated in FIG. 15, if “HE” is checked, “2” is automatically input to the input box B113, and “H” and “E” are automatically input to the spin boxes B115 of the pigments (1) and (2), respectively. In the first embodiment, since the specimen S is subjected to the HE staining, the user can check “HE” in the standardized staining selecting unit B111 and register the staining pigment (morphological observation pigment). In this case, information of the registered staining pigment is set as the morphological observation staining information 515 (refer to (b) in FIG. 11) of the staining information 514 (refer to (b) in FIG. 10) in the VS image file 5.

Similar to the morphological observation registration screen W11, in the molecule target registration screen W13, an input box B133 that is used to input the number of molecule target pigments and a plurality of spin boxes B135 that are used to select the molecule target pigments are disposed. Each of the spin boxes B135 provides a list of pigment names as a choice and urges the selection. The provided pigments are not particularly exemplified, but appropriately include pigments known in molecule target staining. The user operates the input unit 41 to input the number of molecule target pigments actually staining the specimen S in the input box B133, selects the pigment names in the spin boxes B135, and registers staining information.

The molecule target registration screen W13 includes a standardized staining selecting unit B131 that provides main labeling enzymes or a combination thereof. The choice that is provided by the standardized staining selecting unit B131 is not limited to the exemplified choice, and may be selected by the user. In the first embodiment, the molecule target pigment is the DAB pigment. As illustrated in FIG. 15, if “DAB” is checked in the standardized staining selecting unit B131, the staining pigment (molecule target pigment) can be registered. Specifically, at this time, “1” is automatically input to the input box B133, and “DAB” is automatically input to the spin box B135 of the pigment (1). In this case, information of the registered staining pigment is set as the molecule target staining information 516 (refer to (b) in FIG. 11) of the staining information 514 (refer to (b) in FIG. 10) in the VS image file 5.

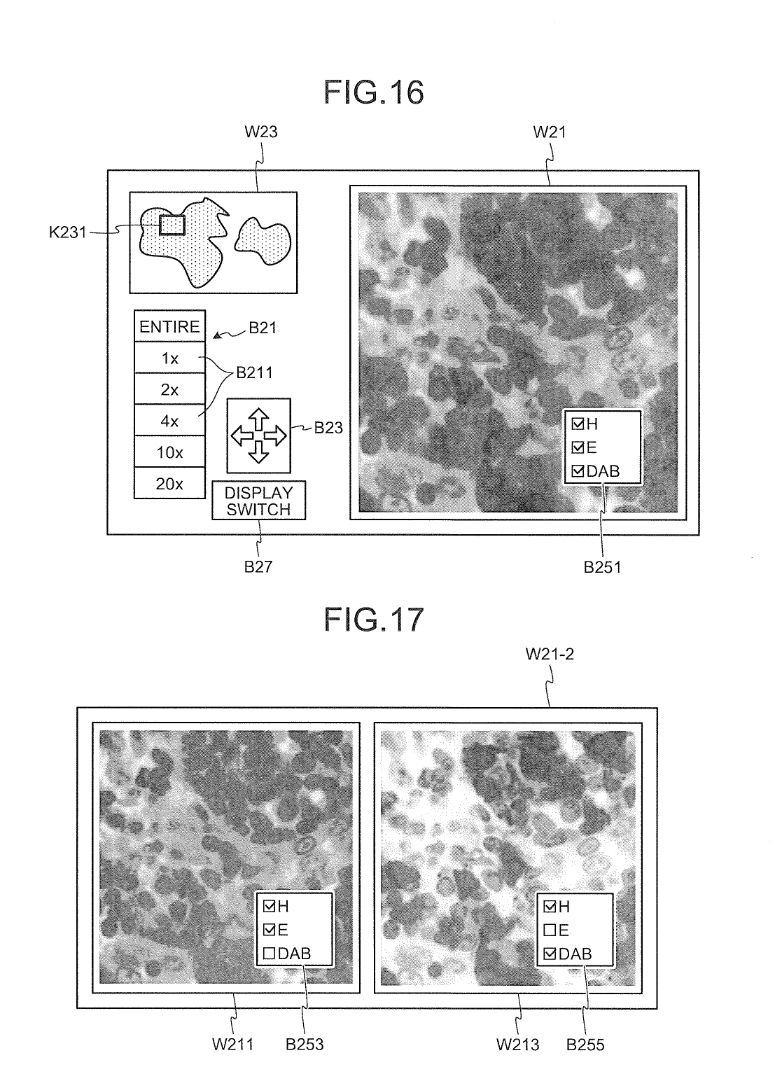

Next, an operation example of when the display image is displayed on the display unit 43 and the VS image is observed will be described. FIG. 16 illustrates an example of a VS image observation screen. As illustrated in FIG. 16, the VS image observation screen includes a main screen W21, an entire specimen image navigation screen W23, a magnification selecting unit B21, an observation range selecting unit B23, and a display switching button 527.

In the main screen W21, on the basis of a VS image obtained by synthesizing specimen area section images corresponding to high-resolution images, a display image that is generated for display according to a display target pigment is displayed. In the main screen W21, the user can observe the entire area or individual section areas of the specimen S with high resolution by using the same method as that in the case where the specimen S is actually observed using the high-magnification objective lens in the microscope apparatus 2.

If the user clicks a right button of a mouse on a display image that is displayed on the main screen W21, a selection menu B251 of a display target pigment exemplified in FIG. 16 is displayed. In the selection menu B251 of the display target pigment, a staining pigment is provided as a choice, and the staining pigment that is checked in the selection menu B251 of the display target pigment is selected as the display target pigment. In the first embodiment, “H”, “E”, and “DAB” that are the staining pigments are provided. For example, in the selection menu B251 of the display target pigment, if “H” is checked, the processes of steps b23 to b25 of FIG. 14 are executed. That is, the display image generating unit 457 generates a display image where only a staining state of the H pigment is displayed on the basis of the pigment amount of the H pigment in each pixel in a current observation range of the VS image, and the VS image display processing unit 454 displays the display image on the display unit 43 (in detail, main screen W21). This is applicable to the case where “E” or “DAB” is selected. In the selection menu B251 of the display target pigment illustrated in FIG. 16, all of “H”, “E”, and “DAB” are checked, and the display image of the main screen W21 displays all staining states of the pigments, on the basis of the pigment amounts of the staining pigments “H”, “E”, and “DAB”.

In the entire specimen image navigation screen W23, an entire image of a slide specimen is reduced and displayed. On the entire image of the slide specimen, a cursor K231 that indicates an observation range corresponding to a range of the display image displayed on the current main screen W21 is displayed. The user can easily grasp a current observation portion of the specimen S, in the entire specimen image navigation screen W23.

The magnification selecting unit B21 selects a display magnification of the display image of the main screen W21. In the example illustrated in FIG. 16, magnification changing buttons B211 that are used to select individual display magnifications of “entire”, “1×”, “2×”, “4×”, “10×”, and “20×” are disposed. In the magnification selecting unit B21, the magnification of the high-magnification objective lens that is used to observe the specimen S is provided as the maximum display magnification. If the user uses the mouse constituting the input unit 41 to click the desired magnification changing button B211, the display image that is displayed on the main screen W21 is expanded and reduced according to the selected display magnification and displayed.

The observation range selecting unit B23 moves the observation range of the main screen W21. For example, if the user clicks arrows of the upper, lower, left, and right using the mouse, a display image where the observation range is moved in a desired movement direction is displayed on the main screen W21. For example, the observation range may be configured to be moved according to an operation of arrow keys included in a keyboard constituting the input unit 41 or a drag operation of the mouse on the main screen W21. The user operates the observation range selecting unit B23 and moves the observation range of the main screen W21, thereby observing the individual portions of the specimen S in the main screen W21.

The display switching button B27 switches the display of the main screen W21. FIG. 17 illustrates an example of a main screen W21-2 that is switched by pressing a display switching button B27. As illustrated in the main screen W21 of FIG. 16 and the main screen W21-2 of FIG. 17, if the display switching button B27 is pressed, a single mode where one display image is displayed on the main screen W21 and a multi mode where the main screen W21-2 is divided into two or more screens and a plurality of display images are displayed can be switched. In FIG. 17, the main screen W21-2 of the configuration of the two screens as the multi mode is exemplified. However, the main screen may be divided into three or more screens and three or more display images may be displayed.

In divided screens W211 and W213 of the main screen W21-2, display target pigments can be individually selected, and display images where the pigment amounts of the display target pigments are displayed are displayed. Specifically, as illustrated in FIG. 17, if the user clicks the right button of the mouse on the divided screen W211, a selection menu B253 of the display target pigment is displayed. In the selection menu B253 of the display target pigment, if the display target pigment is checked, a display image where the pigment amount of the desired pigment is displayed can be displayed. In the same way, if the user clicks the right button of the mouse on the divided screen W213, a selection menu B255 of the display target pigment is displayed. In the selection menu B255 of the display target pigment, if the display target pigment is checked, a display image where the pigment amount of the desired pigment is displayed can be displayed. For example, in the selection menu B253 of the display target pigment on the divided screen W211 of the left side in FIG. 17, “H” and “E” are selected, and the display image of the divided screen W211 displays staining states of the two pigments, on the basis of the pigment amounts of the staining pigments “H” and “E”. Meanwhile, in the selection menu B255 of the display target pigment on the divided screen W213 of the right side in FIG. 17, “H” and “DAB” are selected, and the display image of the divided screen W213 displays staining states of the two pigments, on the basis of the pigment amounts of the staining pigments “H” and “DAB”. The selection menus B253 and B255 of the display target pigments or the selection menu B251 of the display target pigment illustrated in FIG. 16 is configured to disappear when the user clicks the left button of the mouse on the screen away from the display of the menus, and can be displayed according to necessity.

According to this configuration, in the single mode, as exemplified in the main screen W21 of FIG. 16, a display image where all staining states of the H pigment, the E pigment, and the DAB pigment are displayed can be observed. Meanwhile, in the multi mode, as exemplified in the main screen W21-2 of FIG. 17, a display image where staining states of the H pigment and the E pigment corresponding to the morphological observation pigments are displayed and a display image where staining states of the DAB pigment corresponding to the molecule target pigment and the H pigment corresponding to the contrast staining are displayed can be observed while comparing the display images with each other.

As described above, according to the first embodiment, a VS image having high resolution and a wide field where the entire area of the specimen S multi-stained by the plurality of pigments is reflected can be generated, and a display image can be generated on the basis of the VS image and displayed on the display unit 43. At this time, since a display image where a staining state of the display target pigment selected according to the user operation is displayed can be generated and displayed on the display unit 43, an effect of improving visibility of the display image can be achieved. The user can select the desired pigments from the staining pigments and individually or collectively observe staining states of the selected pigments. Accordingly, the morphology of the specimen S and the expressed molecule information can be observed while being contrasted with each other on the same specimen.

According to the first embodiment, the display image of the VS image is generated whenever the display target pigment is selected. Meanwhile, like a display image where the display target pigments are used as the H pigment and the E pigment or a display image where the display target pigments are used as the H pigment and the DAB pigment (that is, display image where an expression of a target molecule to which contrast staining of a nucleus by the H staining is added is displayed), a display image where the representative pigments are combined in advance may be generated and recorded in the VS image file 5. When the combination of the representative pigments is selected as the display target pixels, the recorded display image may be read and displayed on the display unit 43. According to this configuration, a high-speed VS image display process can be realized.

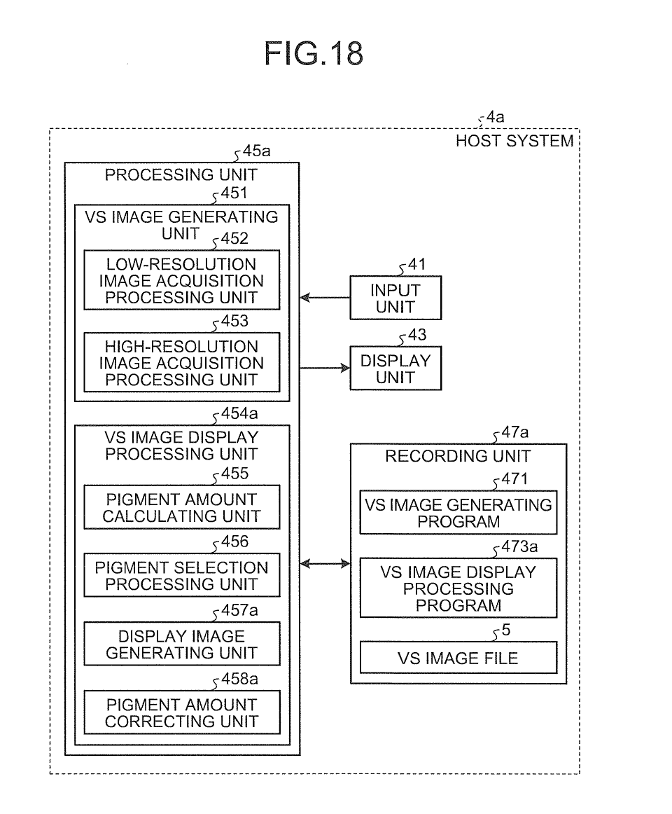

In the first embodiment, the pigment amount at each specimen position on the corresponding specimen S is calculated on the basis of the pixel value of each pixel of the VS image. In this case, the calculated pigment amount may be configured to be corrected. FIG. 18 illustrates a main functional block of a host system 4a according to a second embodiment. In the second embodiment, the same components as those described in the first embodiment are denoted by the same reference numerals. As illustrated in FIG. 18, the host system 4a that constitutes a microscope system according to the second embodiment includes the input unit 41, the display unit 43, a processing unit 45a, and a recording unit 47a.

A VS image display processing unit 454a of the processing unit 45a includes the pigment amount calculating unit 455, the pigment selection processing unit 456, a display image generating unit 457a, and a pigment amount correcting unit 458a. The pigment amount correcting unit 458a receives selection of a pigment of a correction target (correction target pigment) and an operation input of a correction coefficient from the user, and corrects the pigment amount of a correction target pigment in each pixel according to the received correction coefficient. In the recording unit 47a, a VS image display processing program 473a that causes the processing unit 45a to function as the VS image display processing unit 454a is recorded.

In the second embodiment, when the pigment amount correcting unit 458a receives a correction instruction of the pigment amount through the input unit 41 during the execution of the VS image display process, the pigment amount correcting unit 458a corrects the pigment amount of the correction target pigment according to the correction coefficient. When the pigment amount correcting unit 458a corrects the pigment amount, the display image generating unit 457a recalculates an RGB value of each pixel on the basis of the pigment amount after the correction (corrected pigment amount) and generates a display image. The VS image display processing unit 454a executes a process of updating the generated display image and displaying the display image on the display unit 43 (for example, the main screen W21 of the single mode illustrated in FIG. 16 or the main screen 21-2 of the multi mode illustrated in FIG. 17).

In this case, the correcting process of the pigment amount that is executed by the pigment amount correcting unit 458a can be realized by applying the known technology disclosed in Japanese Unexamined Patent Application Publication No. 2008-51654. The process sequence of the pigment amount correcting process will be simply described. First, the pigment amount of the pigment that is selected as the correction target pigment among the pigment amounts of the display target pigments is multiplied by the received correction coefficient and the calculation result is substituted for Equation 2, and an RGB value of each pixel is calculated in the same way as the process of converting the pigment amount into the RGB value, which is described in step b24 of FIG. 14. That is, only the pigment amounts of the display target pigments are considered, the pigment amount of the correction target pigment among the display target pigments is corrected according to the corrected pigment amount, and the RGB value is calculated.

In this case, an operation example of when the pigment amount is corrected will be described. In the second embodiment, in a VS image observation screen illustrated in FIG. 16, a correction menu of the pigment amount is provided. The provision of the correction menu may be realized by arranging a button used to select the correction menu on the screen, or the correction menu may be provided when the user clicks the right button of the mouse on the VS image observation screen. The user selects the correction menu, when the correction target pigment is selected and the pigment amount thereof is corrected.

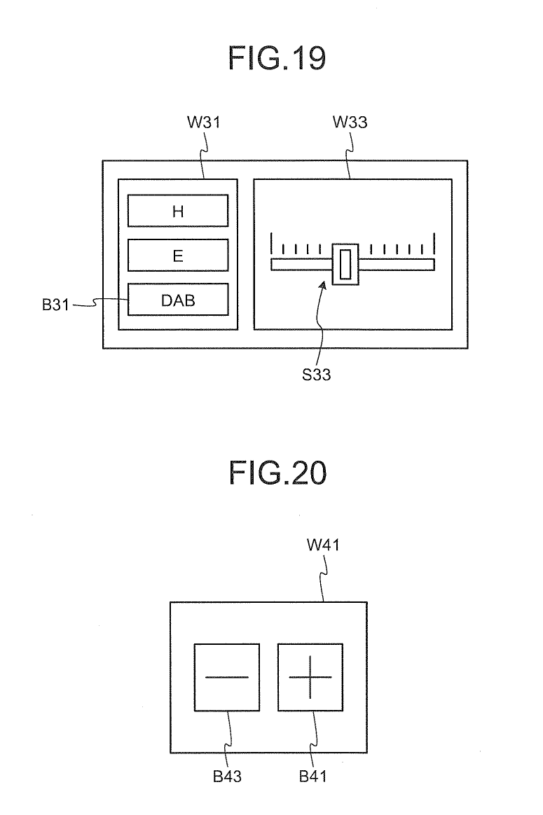

FIG. 19 illustrates an example of a pigment correction screen that is displayed on the display unit 43, when the correction menu is selected. As illustrated in FIG. 19, the pigment correction screen includes a correction pigment selection screen W31 and a correction coefficient adjustment screen W33. In the correction pigment selection screen W31, a pigment selection button B31 that is used to individually select a currently selected display target pigment is disposed. For example, if the pigment selection button B31 is pressed, the DAB pigment is selected as the correction target pigment. Meanwhile, in the correction coefficient adjustment screen W33, a slider S33 that is used to adjust a correction coefficient is displayed. The user moves the slider S33 and inputs a desired correction coefficient with respect to the correction target pigment.

FIG. 20 illustrates another example of a correction coefficient adjustment screen. In a correction coefficient adjustment screen W41 of FIG. 20, a + button B41 that is used to increase a correction coefficient value and a − button B43 that is used to decrease the correction coefficient value are disposed. The user presses the + button B42 or the − button B43 and inputs a desired correction coefficient with respect to the correction target pigment.

For example, when a display image where the H pigment, the E pigment, and the DAB pigment are used as the display target pigments is displayed on the main screen W21 of FIG. 16, a morphological observation may need to be preferentially performed. According to the second embodiment, in the above case, a display image where the pigment amount of the DAB pigment is suppressed (DAB pigment is diluted) for an easy morphological observation and visibility of the H pigment and the E pigment is improved can be displayed.

For example, it is assumed that a display image where the H pigment and the DAB pigment are used as the display target pigments is displayed. As such, if the H pigment and the DAB pigment are used as the display target pigments, under the contrast staining of a nucleus by the H pigment, a staining state of the DAB pigment (that is, expression of the target molecule thereof) can be observed. In this case, a display image where the pigment amount of the H pigment is suppressed for an easy observation and visibility of the DAB pigment is improved can be displayed.

When the specimen is subjected to the morphological observation staining and the molecule target staining to be multi-stained, plural pigments overlap on the specimen and the transmittance of the specimen is lowered. According to the second embodiment, the specimen can be subjected to the diluted HE staining as compared with the common case and the corresponding image can be corrected to an image having the same color as the specimen subjected to the HE staining when the display image is generated. Accordingly, the above-described problem can be resolved.

As described above, according to the second embodiment, the same effect as that of the first embodiment can be achieved, the user can selectively adjust the brightness of the display target pigment, and the visibility of the staining state of the display target pigment on the display image can be improved.

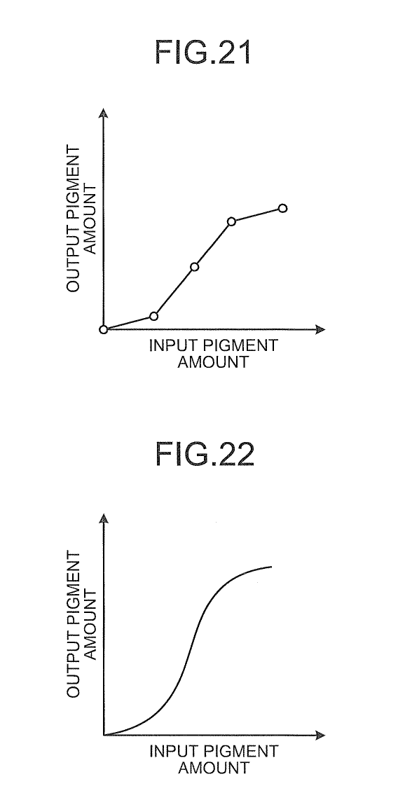

The correction of the pigment amount is not limited to the correction that is performed by directly inputting the correction coefficient value as illustrated in FIG. 19 or 20. For example, a look-up table where the pigment amount calculated on the basis of the pixel values of the VS image is input as the input pigment amount and the corrected pigment amount is output as the output pigment amount may be defined in advance and recorded in the recording unit 47a, and the pigment amount may be corrected with reference to the look-up table. FIG. 21 illustrates an example of a look-up table. FIG. 22 illustrates another example of the look-up table. FIGS. 21 and 22 schematically illustrate a look-up table where a horizontal axis indicates the pigment amount to be input (input pigment amount) and a vertical axis indicates the corrected pigment amount to be output (output pigment amount). That is, the look-up table may be defined as the data table where a correspondence relationship between the input pigment amount and the corrected pigment amount is defined as illustrated in FIG. 21 or may be defined as a function as illustrated in FIG. 22.

In the second embodiment, one correction target pigment is selected and the pigment amount is corrected with respect to the selected correction target pigment, but the following configuration may be realized. That is, when the correction menu is selected, a correction coefficient adjustment screen where sliders or buttons used to adjust correction coefficients of the individual display target pigments are arranged may be displayed, and the plural display target pigments may be set as the correction target pigments and simultaneously adjusted.

The correction coefficient adjustment screen may be displayed on the main screen W21 of FIG. 16 or the main screen W21-2 of FIG. 17, and the display images on the main screens W21 and W21-2 may be updated and displayed in real time according to the operation of the slider or the button. According to this configuration, the user can adjust the correction coefficients while viewing the display images on the main screens W21 and W21-2, and change the staining state of the display target pigment to be easily viewed. Therefore, operability can be improved.

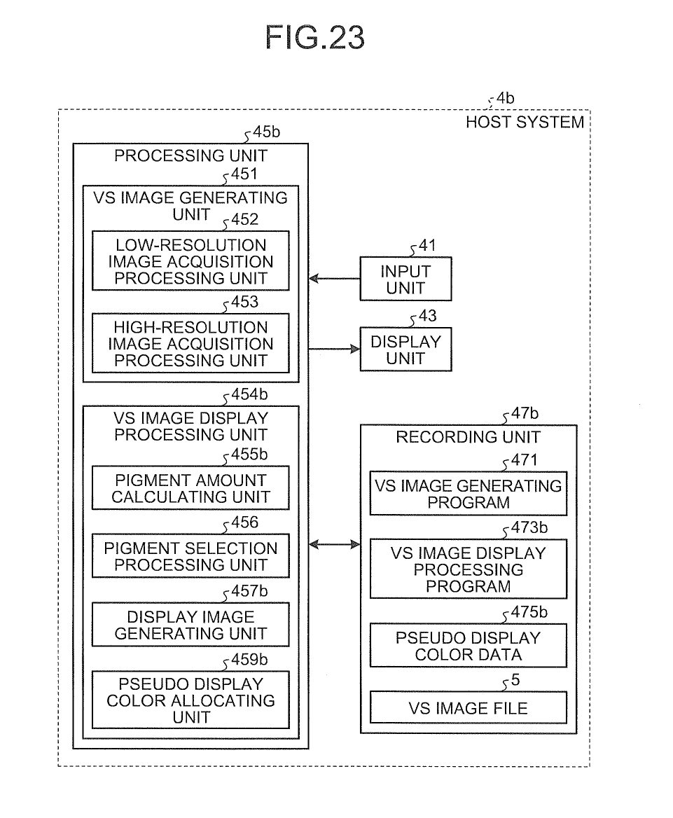

FIG. 23 illustrates a main functional block of a host system 4b according to a third embodiment. In the third embodiment, the same components as those described in the first embodiment are denoted by the same reference numerals. As illustrated in FIG. 23, the host system 4b that constitutes a microscope system according to the third embodiment includes the input unit 41, the display unit 43, a processing unit 45b, and a recording unit 47b.

A VS image display processing unit 454b of the processing unit 45b includes a pigment amount calculating unit 455b, the pigment selection processing unit 456, a display image generating unit 457b, and a pseudo display color allocating unit 459b that functions as a display color allocating unit. Meanwhile, in the recording unit 47b, a VS image display processing program 473b that causes the processing unit 45b to function as the VS image display processing unit 454b is recorded. In the recording unit 47b, pseudo display color data 475b is recorded.

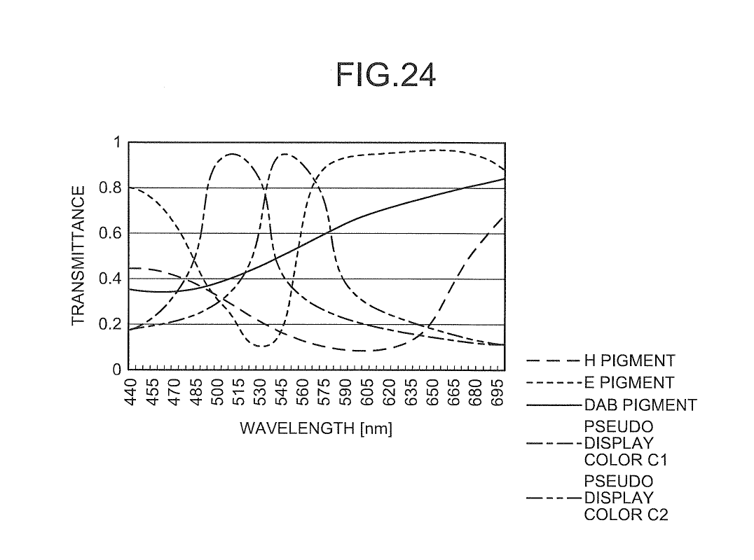

FIG. 24 illustrates an example of a spectral transmittance characteristic (spectrum) of a pseudo display color. In FIG. 24, spectrums of two kinds of pseudo display colors C1 and C2 and spectrums of the H pigment, the E pigment, and the DAB pigment are illustrated. In the third embodiment, as in the pseudo display color C1 or C2 illustrated in FIG. 24, a spectrum of a pseudo display color that is different from the spectrum of the H pigment or the E pigment corresponding to the morphological staining pigment and has saturation higher than that of the H pigment or the E pigment is prepared. The spectrum of the pseudo display color is recorded as pseudo display color data 475b in the recording unit 47b in advance and used as a spectrum of the molecule target pigment.

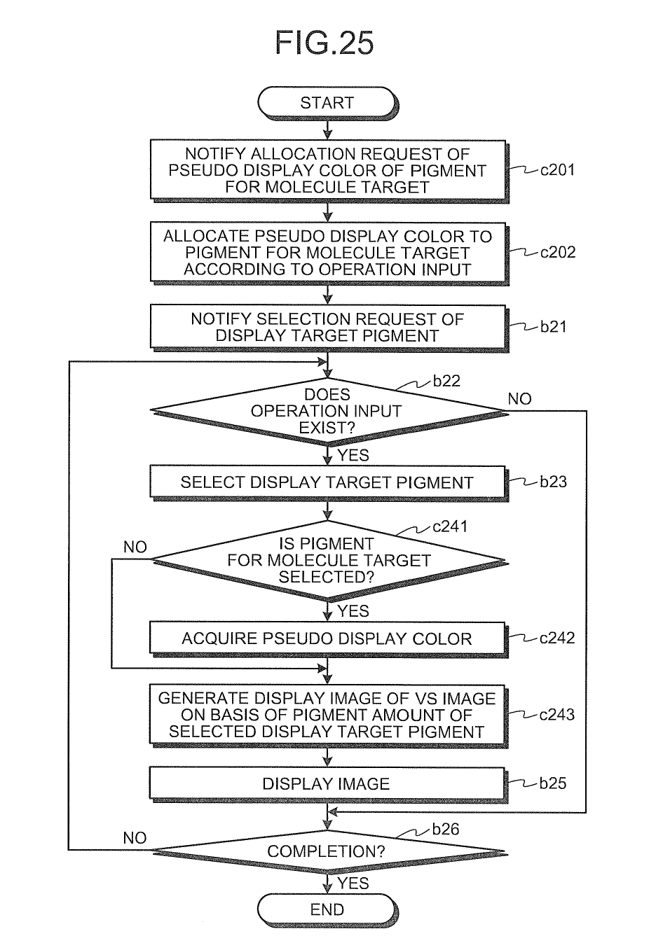

FIG. 25 is a flowchart illustrating a process sequence of a display process of a VS image in the third embodiment. The process described herein is realized when the VS image display processing unit 454b reads the VS image display processing program 473b recorded in the recording unit 47b and executes the VS image display processing program. The same processes as those in the first embodiment are denoted by the same reference numerals.

As illustrated in FIG. 25, in the third embodiment, first, the pseudo display color allocating unit 459b executes a process of displaying a notification of an allocation request of the pseudo display color allocated to the molecule target pigment included in the staining pigment on the display unit 43 (Step d201). For example, the pseudo display color allocating unit 459b provides a list of prepared pseudo display colors and receives a selection operation of the pseudo display color allocated to the molecule target pigment. When plural molecule target pigments are included in the staining pigments, the pseudo display color allocating unit 459b individually receives the selection operation of the pseudo display color allocated to each molecule target pigment. The pseudo display color allocating unit 459b allocates the pseudo display color to the molecule target pigment according to the operation input from user given in response to the notification of the allocation request (Step c202).

Next, similar to the first embodiment, the pigment selection processing unit 456 executes a process of displaying a notification of a selection request of the display target pigment on the display unit 43 (Step b21). If the operation input is not given in response to the notification of the selection request (Step b22: No), the pigment selection processing unit 456 proceeds to step b26. Meanwhile, when the operation input is given from the user (Step b22: Yes), the pigment selection processing unit 456 selects the pigment as the display target pigment (Step b23).

Next, the display image generating unit 457b determines whether the molecule target pigment is selected as the display target pigment. When the molecule target pigment is not selected (Step c241: No), the display image generating unit 457b proceeds to step c243. Meanwhile, when the molecule target pigment is selected (Step c241: Yes), the display image generating unit 457b acquires the pseudo display color that is allocated to the molecule target pigment in step c202 (Step c242).

Next, in step c243, the display image generating unit 457b calculates an RGB value of each pixel on the basis of the pigment amount of each display target pigment in each pixel and generates a display image. At this time, when the molecule target pigment is included in the display target pigment, the spectrum of the pseudo display color (that is, pseudo display color allocated to the molecule target pigment by the pseudo display color allocating unit 459b) acquired in step c202 is used as a reference pigment spectrum of the molecule target pigment, and the RGB value is calculated. Specifically, the reference pigment spectrum kₙ(λ) of the molecule target pigment that is substituted for Equation 5 and used is replaced by the spectrum of the pseudo display color allocated to the molecule target pigment, the spectrum estimation is performed, and the RGB value is calculated on the basis of the estimation result.

In the first embodiment, the pigment amount at each specimen position on the specimen S that corresponds to each pixel constituting the VS image is calculated, the RGB value of each pixel is calculated on the basis of the calculated pigment amount, and the display image is generated. In this case, the morphological observation staining is used to observe the morphology, while the molecule target staining of the specimen is used to know a degree to which the target molecule is expressed. For this reason, with respect to the display of the staining state by the molecule target staining, the staining state may be displayed by a color different from the color actually staining the specimen.

As described above, according to the third embodiment, the same effect as that of the first embodiment can be achieved, and the pseudo display color can be allocated to the molecule target pigment. As the reference pigment spectrum of the molecule target pigment, a spectrum that is different from the spectrum (in this case, spectral transmittance characteristic) that the pigment originally has can be used. That is, with respect to the staining state of the morphological observation pigment, the same color as the pigment actually staining the specimen is reproduced and displayed. With respect to the staining state of the molecule target pigment, the display can be made by the pseudo display color to improve the contrast with respect to the morphological observation pigment. According to this configuration, the staining state by the molecule target pigment can be displayed with a high contrast. Accordingly, even when the molecule target pigment and the morphological observation pigment or other molecule target pigments are visualized by similar colors, the pigments can be displayed to be easily identified, and the visibility at the time of the observation can be improved.

When the pseudo display color allocating unit 459b allocates the pseudo display color to the molecule target pigment, a correspondence relationship between the molecule target pigment and the pseudo display color may be recorded in the recording unit 47b. According to this configuration, it is not needed to execute the processes of steps c201 and c202 of FIG. 25 whenever the specimen is changed and set the pseudo display color of the molecule target pigment included in the staining pigment. Accordingly, operability can be improved.

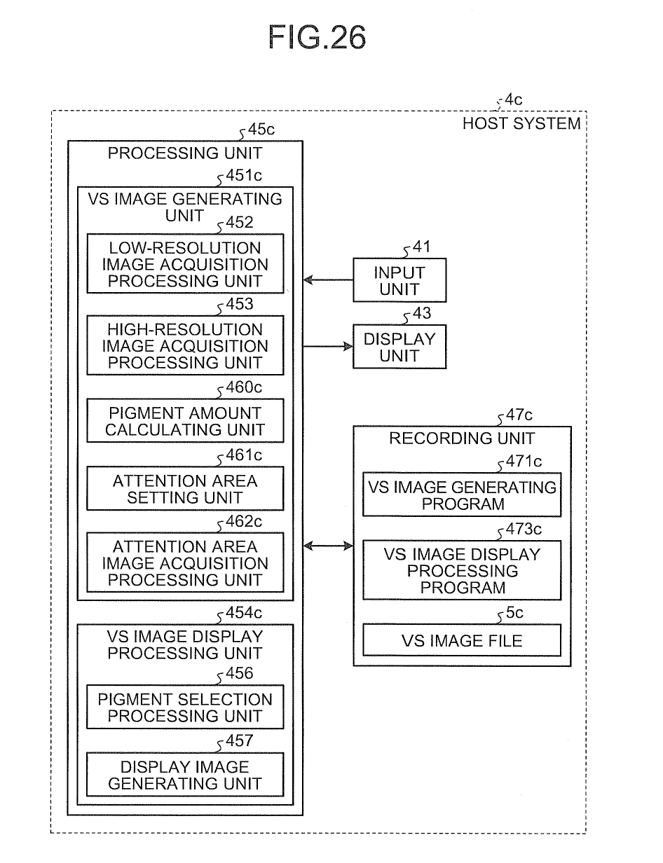

FIG. 26 illustrates a main functional block of a host system 4c according to a fourth embodiment. In the fourth embodiment, the same components as those described in the first embodiment are denoted by the same reference numerals. As illustrated in FIG. 26, the host system 4c includes the input unit 41, the display unit 43, a processing unit 45c, and a recording unit 47c.

Although not illustrated in FIG. 26, in a microscope system according to the fourth embodiment, the high-magnification objective lens and the low-magnification objective lens described in the first embodiment and an objective lens (highest-magnification objective lens) having a higher magnification than that of the high-magnification objective lens are mounted are mounted in a revolver of a microscope apparatus that is connected to the host system 4c. Hereinafter, an objective lens that has a magnification of 2× is exemplified as the low-magnification objective lens, an objective lens that has a magnification of 10× is exemplified as the high-magnification objective lens, and an objective lens that has a magnification of 60× is exemplified as the highest-magnification objective lens.

In the host system 4c according to the fourth embodiment, a VS image generating unit 451c of the processing unit 45c includes the low-resolution image acquisition processing unit 452, the high-resolution image acquisition processing unit 453, a pigment amount calculating unit 460c, an attention area setting unit 461c, and an attention area image acquisition processing unit 462c that functions as an attention area image acquiring unit and a magnification changing unit. The attention area setting unit 461c selects a high expression portion of a target molecule as an attention area. The attention area image acquisition processing unit 462c outputs an operation instruction of each unit of the microscope apparatus and acquires a high-resolution image of the attention area. In this case, the attention area image is acquired as a multi-band image at a plurality of Z positions, using the highest-magnification objective lens at the time of observing the specimen.

That is, in the fourth embodiment, the low-resolution image acquisition processing unit 452 acquires a low-resolution image using an objective lens of 2× (low-magnification objective lens). The high-resolution image acquisition processing unit 453 acquires a high-resolution image using an objective lens of 10× (high-magnification objective lens). The attention area image acquisition processing unit 462c acquires a three-dimensional image of an attention area (attention area image) using an objective lens of 60× (highest-magnification objective lens). In the same way as that of the first embodiment, the pigment amount calculating unit 460c calculates the pigment amount of each staining pigment at each specimen position on the corresponding specimen, on the basis of a pixel value of each pixel constituting the high-resolution image, and calculates the pigment amount of each staining pigment at each specimen position on the corresponding specimen, on the basis of a pixel value of each pixel constituting the attention area image.

A VS image display processing unit 454c includes the pigment selection processing unit 456 and the display image generating unit 457. In the fourth embodiment, the VS image display processing unit 454c executes the display process of the VS image described in FIG. 14, as the VS image display process. The calculating of the pigment amount is performed by the VS image generating process.

Meanwhile, in the recording unit 47c, a VS image generating program 471c that causes the processing unit 45c to function as the VS image generating unit 451c, a VS image display processing program 473c that causes the processing unit 45c to function as the VS image display processing unit 454c, and a VS image file 5c are recorded.

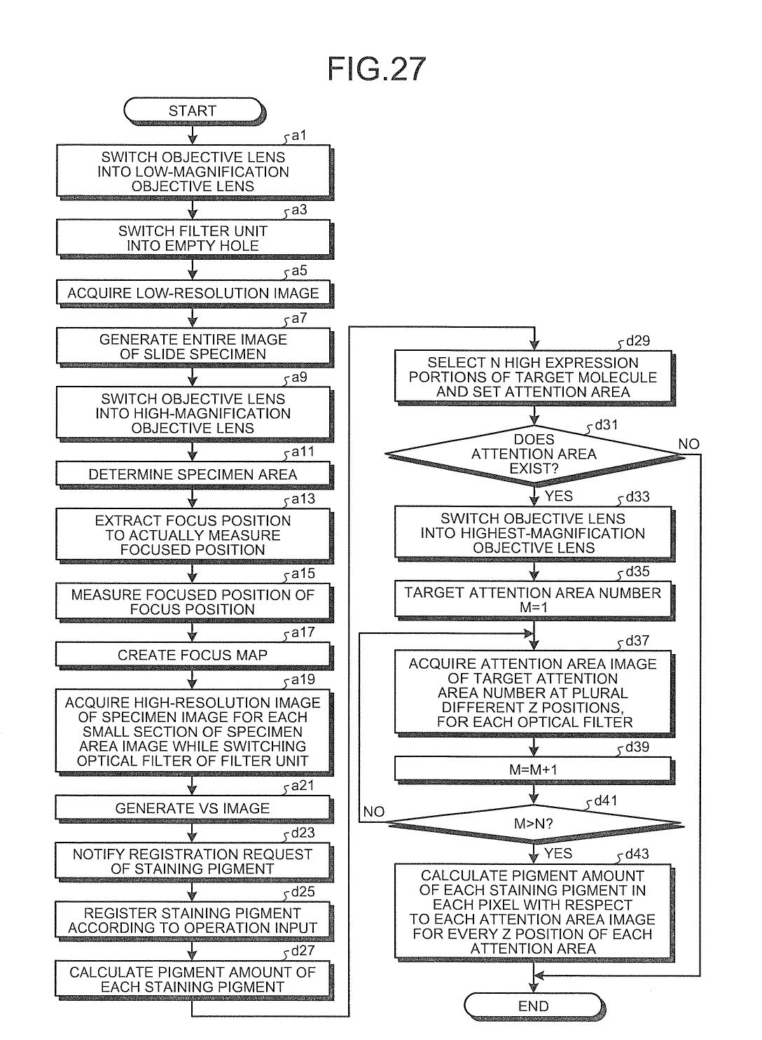

Next, the VS image generating process according to the fourth embodiment will be described. FIG. 27 is a flowchart illustrating the operation of a microscope system according to the fourth embodiment that is realized when the processing unit 45c of the host system 4c executes the VS image generating process. The operation of the microscope system that is described herein is realized when the processing unit 45c reads the VS image generating program 471c recorded in the recording unit 47c and executes the VS image generating program. The same processes as those of the first embodiment are denoted by the same reference numerals.

In the fourth embodiment, after the high-resolution image acquisition processing unit 453 generates the VS image in step a21, the VS image generating unit 451c executes a process of displaying a notification of a registration request of the staining pigment staining the specimen on the display unit 43 (Step d23). Next, the VS image generating unit 451c registers the pigment, which is input by the user in response to the notification of the registration request, as the staining pigment (Step d25). Next, the pigment amount calculating unit 460c calculates the pigment amount at each specimen position on the corresponding specimen for each staining pigment, on the basis of a pixel value of each pixel of the generated VS image (Step d27).

Next, the attention area setting unit 461c extracts a high expression portion of the target molecule from the VS image, and sets the high expression portion as the attention area (Step d29). For example, the attention area setting unit 461c selects portions (having a high concentration) where the pigment amount of the DAB pigment corresponding to the molecule target pigment included in the staining pigments is equal to or larger than a predetermined threshold value and a high expression area is larger than a predetermined area (for example, field range of the high-magnification objective lens) by N (for example, 5).

Specifically, first, the attention area setting unit 461c divides the area of the VS image according to the predetermined area and counts the number of pixels where the pigment amount of the DAB pigment is equal to or larger than the predetermined threshold value in each divided area. The attention area setting unit 461c selects five areas from the areas where the count value is equal to or larger than the predetermined reference pixel number in the order of the areas having the large values and sets the selected areas as the attention areas. When the number of areas where the count value is equal to or larger than the reference pixel number is smaller than 5, all the areas are set as the attention areas. While the VS image may be scanned from the upper left end and an area having a predetermined size is shifted for every n pixels (for example, for every four pixels), the number of pixels where the pigment amount of the DAB pigment is equal to or larger than the predetermined threshold value may be counted with respect to each area. Among the areas where the count value is equal to or larger than the reference pixel number, the five areas may be set as the attention areas.

When there is no area that is set as the attention area, that is, there is no area where the count value for each area is equal to or larger than the reference pixel number (Step d31: No), the corresponding process is completed. That is, with respect to the specimen that has no high expression portion of the target molecule, the generation of the attention area image using the highest-magnification objective lens is not performed.

Meanwhile, when the attention area is set (Step d31: Yes), the attention area image acquisition processing unit 462c outputs an instruction, which causes the objective lens used when the specimen is observed to be switched into the highest-magnification objective lens, to the microscope controller of the microscope apparatus (Step d33). In response to the instruction, the microscope controller rotates the revolver and disposes the highest-magnification objective lens on the optical path of the observation light.

Next, the attention area image acquisition processing unit 462c initializes a target attention area number M with “1” (Step d35). The attention area image acquisition processing unit 462c outputs an instruction, which causes the optical filters for capturing the specimen with multi-bands to be sequentially switched, to the microscope controller, outputs an operation instruction of each unit of the microscope apparatus to the microscope controller or the TV camera controller, captures the specimen image of the attention area of the target attention area number M with multi-bands at a plurality of different Z positions, and acquires an attention area image for each Z position (Step d37).

In response to this, first, in a state where one optical filter of the filter unit is disposed on the optical path of the observation light, the microscope apparatus sequentially captures the specimen image of the attention area of the target attention area number M with the TV camera, while moving the Z position of the electromotive stage. Next, the microscope apparatus disposes the other optical filter on the optical path of the observation light and captures the specimen image of the attention area of the target attention area number M at the plurality of different Z positions, in the same way as the above case. The captured image data is output to the host system 4c and acquired as an attention area image (three-dimensional image) of the attention area of the target attention area number M for each Z position, in the attention area image acquisition processing unit 462c.

The generation of the three-dimensional image can be realized by applying the known technology disclosed in Japanese Unexamined Patent Application Publication No. 2006-343573. However, the number (section number) of captured attention area images in a Z direction is set as the number (566) of sheets in the Z direction in the VS image file 5c in advance (refer to (c) in FIG. 12).

Next, the attention area image acquisition processing unit 462c increments the target attention area number M and updates the target attention area number M (Step d39). When the target attention area number M does not exceed the attention area number (Step d41: No), the attention area image acquisition processing unit 462c is returned to step d37, repeats the above process, and acquires the attention area image for each Z position, with respect to each set attention area.

When the target attention area number M exceeds the attention area number (Step d41: Yes), the pigment amount calculating unit 460c calculates the pigment amount of each staining pigment in each pixel, with respect to each attention area image for each Z position acquired with respect to each attention area (Step d43).

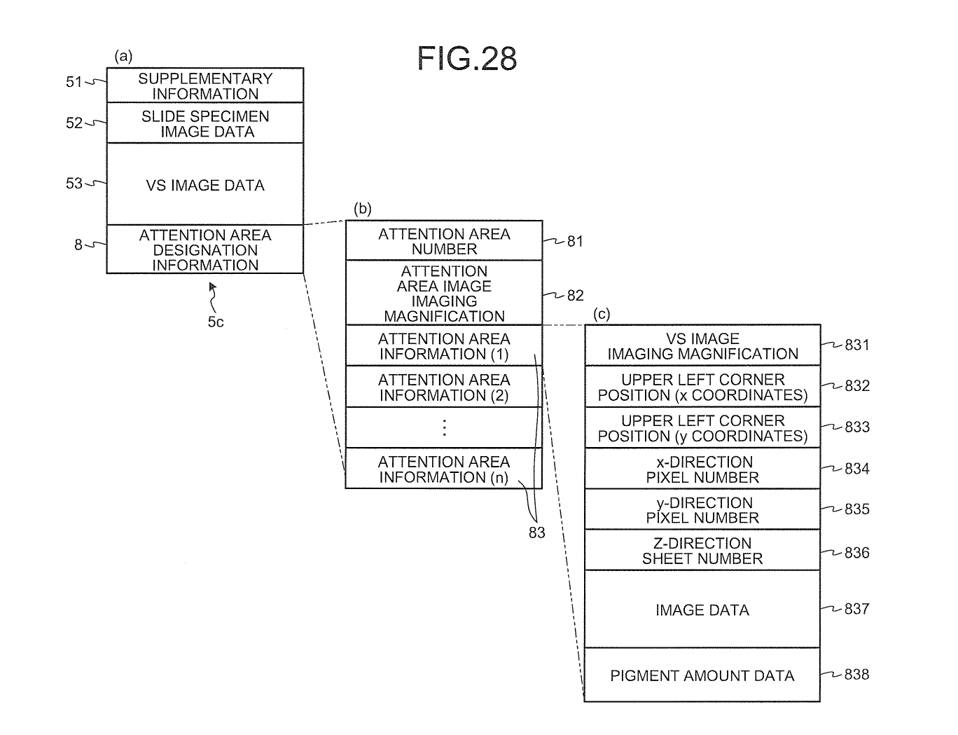

FIG. 28 illustrates an example of the data configuration of the VS image file 5c that is acquired as the result of the VS image generating process and recorded in the recording unit 47c. As illustrated in (a) in FIG. 28, the VS image file 5c according to the fourth embodiment includes the supplementary information 51, the entire slide specimen image data 52, the VS image data 53, and attention area designation information 8.

As illustrated in (b) in FIG. 28, the attention area designation information 8 includes an attention area number 81, an attention area image imaging magnification 82, and attention area information (1) to (n) 83 of the number that corresponds to the attention area number 81. The attention area number 81 corresponds to n, and a value of N that is used in the process of step d29 of FIG. 27 is used. In the attention area information (1) to (n) 83, a variety of information that is related to the attention area images acquired for each attention area is set. That is, in each attention area information 83, a VS image number 831, an upper left corner position (x coordinates) 832, an upper left corner position (y coordinates) 833, an x-direction pixel number 834, a y-direction pixel number 835, a Z-direction sheet number 836, image data 837, and pigment amount data 838 are set, as illustrated in (c) in FIG. 28.

The VS image number 831 is an image number of a VS image that the attention area thereof belongs. Since a plurality of VS images may be generated with respect to one specimen, the VS image number is set to identify the VS image. The upper left corner position (x coordinates) 832, the upper left corner position (y coordinates) 833, the x-direction pixel number 834, and the y-direction pixel number 835 are information used to specify the position in the VS image of the corresponding attention area image. That is, the upper left corner position (x coordinates) 832 indicates the x coordinates of the upper left corner position of the corresponding attention area image in the VS image, and the upper left corner position (y coordinates) 833 indicates the y coordinates of the upper left corner position. The x-direction pixel number 834 is an x-direction pixel number of the corresponding attention area image, and the y-direction pixel number 835 is a y-direction pixel number and indicates a size of the attention area image. The Z-direction sheet number 836 is a Z-direction section number. In the Z-direction sheet number 836, the number of attention area images (number of Z positions) that are generated with respect to the attention area is set.

In the image data 837, image data of the attention area image for each Z position of the corresponding attention area is set. In the pigment amount data 838, data of the pigment amount of each staining pigment that is calculated for each pixel with respect to the attention area image for each Z position in step d37 of the VS image display process of FIG. 27 is set.

In order to determine validity of an expression with respect to a portion where an excessive expression is confirmed by the molecule target staining, nucleus information may need to be three-dimensionally observed using the high-magnification objective lens. According to the fourth embodiment, the same effect as that of the first embodiment can be achieved. The high expression portion of the target molecule can be extracted on the basis of the pigment amount of the molecule target pigment and set as the attention area. The attention area image that is observed with respect to the attention area using the highest-magnification objective lens having the higher magnification than that of the high-magnification objective lens can be acquired as the three-dimensional image. Accordingly, a cell state of a high expression portion of the target molecule where the expression is confirmed by the molecule target staining can be three-dimensionally confirmed with high definition, and a detailed nucleus view of a cell can be obtained while the morphology of the specimen and the expressed molecule information are contrasted with each other. At this time, since the user does not need to select the high expression portion of the target molecule from the VS image or exchange the objective lens, operability can be improved.

In the VS image generating process, if the processes of steps d23 and d25 of FIG. 27 are configured to be executed in advance or first executed during the VS image generating process, the user does not need to perform the operation in the course of the VS image generating process.

In the fourth embodiment, the case where the kind of the molecule target pigment included in the staining pigments is one and the high expression portion is extracted with respect to one kind of target molecule has been described. Meanwhile, when the plural molecule target pigments are included in the staining pigments, the high expression portion of each target molecule may be extracted and set as the attention area. Alternatively, the target molecule to set the attention area may be selected according to the operation from the user, and the high expression portion of the selected target molecule may be set as the attention area. In this case, if the selection of the target molecule from which the high expression portion is extracted is configured to be performed in advance or first performed during the VS image generating process, the user does not need to perform the operation in the course of the VS image generating process.

The attention area may be set according to the operation from the user. For example, the process of displaying the VS image generated in step a21 of FIG. 27 on the display unit 43 may be executed, the VS image may be provided to the user, the area selection operation on the VS image may be received, and the attention area may be set.

The low-luminance portion of the VS image may be set as the attention area. Specifically, the low-luminance portion of the VS image may be extracted and the attention area may be set. The attention area image may be acquired for each Z position of the set attention area. According to this configuration, the low-luminance portion on the specimen where the pigments overlap each other can be three-dimensionally confirmed with high definition.

When the low-luminance portion is set as the attention area, the low-luminance portion of the entire slide specimen image that is generated in step a7 of FIG. 27 may be set as the attention area. In this case, in the VS image generating process of FIG. 27, the processes of steps a11 to a21 may not be executed. According to this configuration, since the high-resolution image of only the low-luminance portion that is estimated as the portion needed to be observed with high definition is acquired, a process load can be alleviated, and a recording capacity that is needed during the recording operation of the recording unit 47c can be reduced. Since the staining pigment does not need to be registered in the course of the process, the operation from the user does not need to be made in the course of the process. Accordingly, when the corresponding system is combined with an autoloader system of the specimen, a continuous automating process by a batch process with respect to the large amount of specimens is enabled.

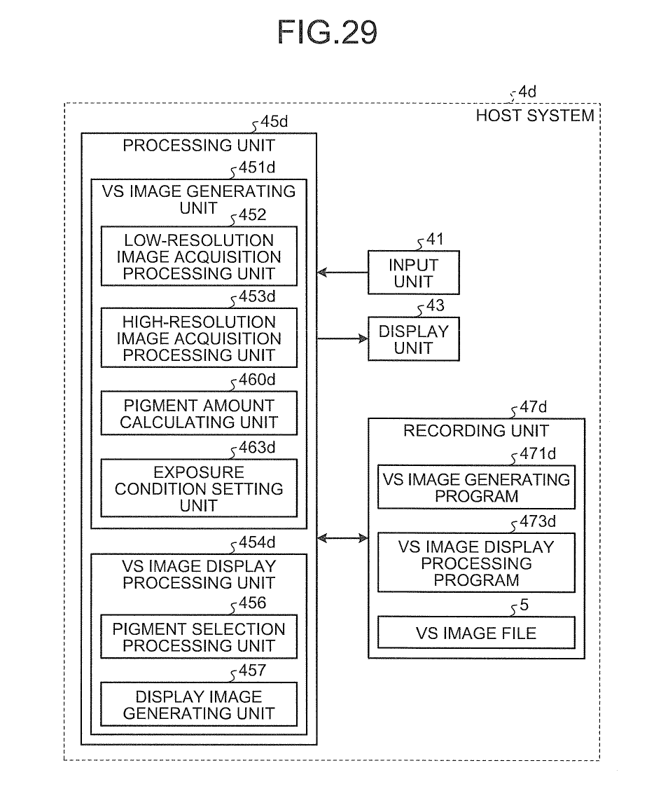

FIG. 29 illustrates a main functional block of a host system 4d according to a fifth embodiment. In the fifth embodiment, the same components as those described in the first embodiment are denoted by the same reference numerals. As illustrated in FIG. 29, the host system 4d that constitutes a microscope system according to the fifth embodiment includes the input unit 41, the display unit 43, a processing unit 45d, and a recording unit 47d.

A VS image generating unit 451d of the processing unit 45d includes the low-resolution image acquisition processing unit 452, a high-resolution image acquisition processing unit 453d, a pigment amount calculating unit 460d, and an exposure condition setting unit 463d. The high-resolution image acquisition processing unit 453d instructs the operation of each unit of the microscope apparatus 2, and sequentially acquires high-resolution images of specimen images (specimen area section images) while stepwisely varying an exposure condition. The exposure condition setting unit 463d stepwisely increases an exposure time T that is an example of the exposure condition and sets the exposure condition, and outputs the exposure condition to the high-resolution image acquisition processing unit 453d.

In this case, the exposure amount of the TV camera that constitutes the microscope apparatus connected to the host system 4d is determined by a product of the exposure time and the incident light amount. Accordingly, if the incident light amount is constant, the exposure amount of the TV camera is determined by the exposure time. For example, if the exposure time becomes double, the exposure amount also becomes double. That is, with respect to a pixel having low luminance, if the exposure time is increased, a dynamic range can be widened, and estimation precision of the pigment amount can be improved. According to the fifth embodiment, the exposure time T is sequentially multiplied by constant numbers (for example, 2) and stepwisely set, the specimen area section image is captured with multi-bands whenever the exposure time T is set, and the estimation precision of the pigment amount is improved.

A VS image display processing unit 454d includes the pigment selection processing unit 456 and the display image generating unit 457. In the fifth embodiment, the VS image display processing unit 454d executes the display process of the VS image illustrated in FIG. 14 as the VS image display process. The calculating of the pigment amount is performed by the VS image generating process.

Meanwhile, in the recording unit 47d, a VS image generating program 471d that causes the processing unit 45d to function as the VS image generating unit 451d, a VS image display processing program 473d that causes the processing unit 45d to function as the VS image display processing unit 454d, and a VS image file 5 are recorded.

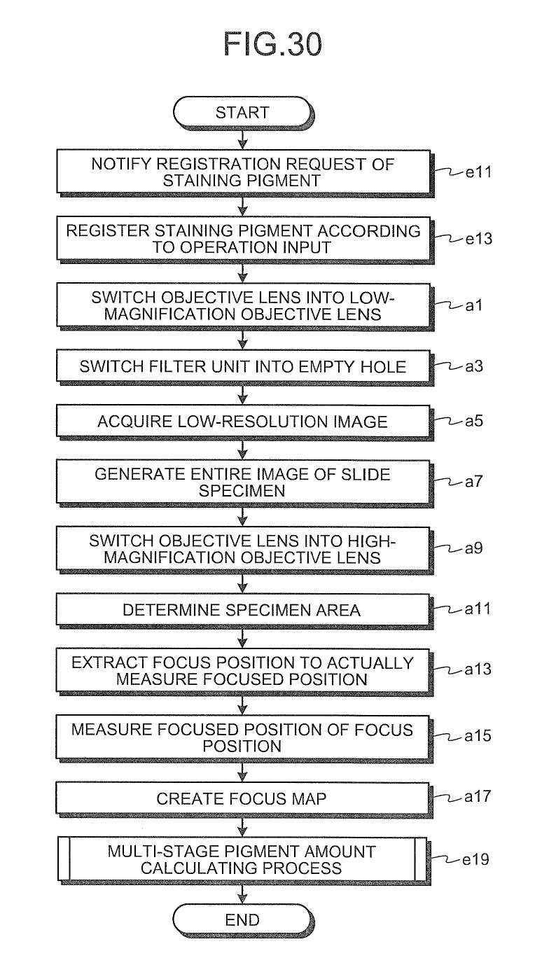

FIG. 30 is a flowchart illustrating the operation of a microscope system that is realized by the VS image generating process according to the fifth embodiment. The process described herein is realized when the VS image generating unit 451d reads the VS image generating program 471d recorded in the recording unit 47d and executes the VS image generating program 471d. The same processes as those of the first embodiment are denoted by the same reference numerals.

As illustrated in FIG. 30, in the fifth embodiment, first, the VS image generating unit 451d executes a process of displaying a notification of a registration request of the staining pigment staining the specimen on the display unit 43 (Step e11). Next, the VS image generating unit 451d registers the pigment, which is input by the user in response to the notification of the registration request, as the staining pigment (Step e13). Next, the VS image generating unit 451d proceeds to step a1.

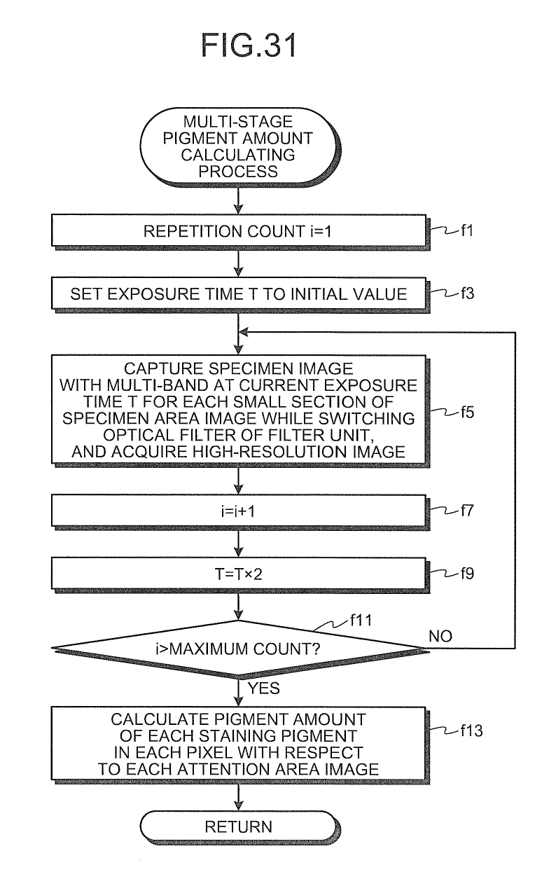

After the VS image generating unit 451d creates a focus map in step a17, the VS image generating unit 451d proceeds to a multi-stage pigment amount calculating process (Step e19). FIG. 31 is a flowchart illustrating a detailed process sequence of the multi-stage pigment amount calculating process.

As illustrated in FIG. 31, in the multi-stage pigment amount calculating process, first, the exposure condition setting unit 463d initializes a repetition count i with “1” (Step f1), and sets the exposure time T to an initial value set in advance (Step f3). In this case, the value that is set as the initial value of the exposure time T is determined such that R, G, and B values of a background portion (portion where a specimen does not exist and transmittance is highest) are in a range of 190 to 230, when an A/D conversion is performed on an output signal of an imaging element using an 8-bit A/D converter.

Next, a high-resolution image acquisition processing unit 433d outputs an instruction, which causes the optical filters for capturing the specimen with multi-bands to be sequentially switched, to the microscope controller, outputs an operation instruction of each unit of the microscope apparatus to the microscope controller or the TV camera controller, captures a specimen image for each small section of the specimen area image with multi-bands at the current exposure time T set by the exposure condition setting unit 463d, and acquires a specimen area section image (high-resolution image) for each small section (Step f5).

In response to this, first, in a state where one optical filter of the filter unit is disposed on the optical path of the observation light, the microscope apparatus sequentially captures the specimen image for each small section of the specimen area image with the TV camera at the instructed current exposure time T. Next, the microscope apparatus disposes the other optical filter on the optical path of the observation light, and captures the specimen image for each small section of the specimen area image at the current exposure time T in the same way as the above case. The captured image data is output to the host system 4d and acquired as the specimen area section image in the high-resolution image acquisition processing unit 453d.

Next, the exposure condition setting unit 463d increments the repetition count i and updates the repetition count i (Step f7). Next, the current exposure time T that is set by the exposure condition setting unit 463d is doubled and updated (Step f9). When the repetition count i does not exceed the maximum count (for example, five) set in advance (Step f11: No), the exposure condition setting unit 463d is returned to step f5, repeats the above process, stepwisely sets the exposure time T, and acquires the specimen area section image.

When the repetition count i exceeds the maximum count (Step f11: Yes), the pigment amount calculating unit 460d calculates the pigment amount of each staining pigment in each pixel with respect to each of the specimen area section images acquired at the different exposure times T (Step f13). Specifically, with respect to each pixel, the pigment amount calculating unit 460d executes the following process. First, the pigment amount calculating unit 460d sets a maximum pixel value that does not exceed detectability of an imaging element of the TV camera at each band as an optimal pixel value and corrects the pixel value according to the exposure time. In the same way as that of the first embodiment, the pigment amount of the corresponding specimen position is estimated (calculated) for every staining pigment, on the basis of the optimal pixel value after the correction. As a result, the dynamic range can be widened and the pigment amount can be estimated. Then, the obtained pigment amount is converted into the pigment amount corresponding to the initial value of the exposure time T.

As described above, according to the fifth embodiment, the same effect as that of the first embodiment can be achieved, and the pigment amount of the low-luminance portion on the specimen where the pigments overlap each other can be calculated with high precision. As a result, in the VS image display process, display precision of the display image where only the pigment amount of the display target pigment is set as the display target can be improved.

In the fifth embodiment, the multi-stage pigment amount calculating process is executed with respect to each small section of the specimen area image. Meanwhile, a luminance value (luminance value Y=0.29891R+0.58661G+0.11448B) of each pixel is calculated on the basis of the entire slide specimen image pixel value (RGB value). With respect to all of the small sections where luminance value is equal to or larger than the predetermined value, it may be determined that calculation precision of the pigment amount can be sufficiently secured, and the multi-stage pigment amount calculating process may not be executed. According to this configuration, the process time can be shortened.

In the fifth embodiment, the exposure condition is stepwisely varied according to the maximum count (5) set in advance, and the five specimen area section images that have the different exposure times T are obtained. However, the five specimen area section images do not need to be acquired. That is, with reference to a pixel value of each pixel constituting the specimen area section image acquired whenever the exposure time T is changed and the specimen area section image is acquired, it may be determined whether a pixel whose pixel value does not satisfy the reference pixel value set in advance exists. When there is no pixel whose pixel value does not satisfy the reference pixel value, the acquiring process of the specimen area section image may be completed and the procedure may proceed to the pigment amount calculating step (Step f13 of FIG. 31). In this way, the process time can be shortened.

In the fifth embodiment, the case where the exposure time is changed and the exposure condition is stepwisely set has been described. However, the exposure condition may be determined by the adjustment of the illumination characteristic or the adjustment of a stop constituting the microscope apparatus. The fifth embodiment may be applied to the case of acquiring the three-dimensional image of the attention area described in the fourth embodiment.

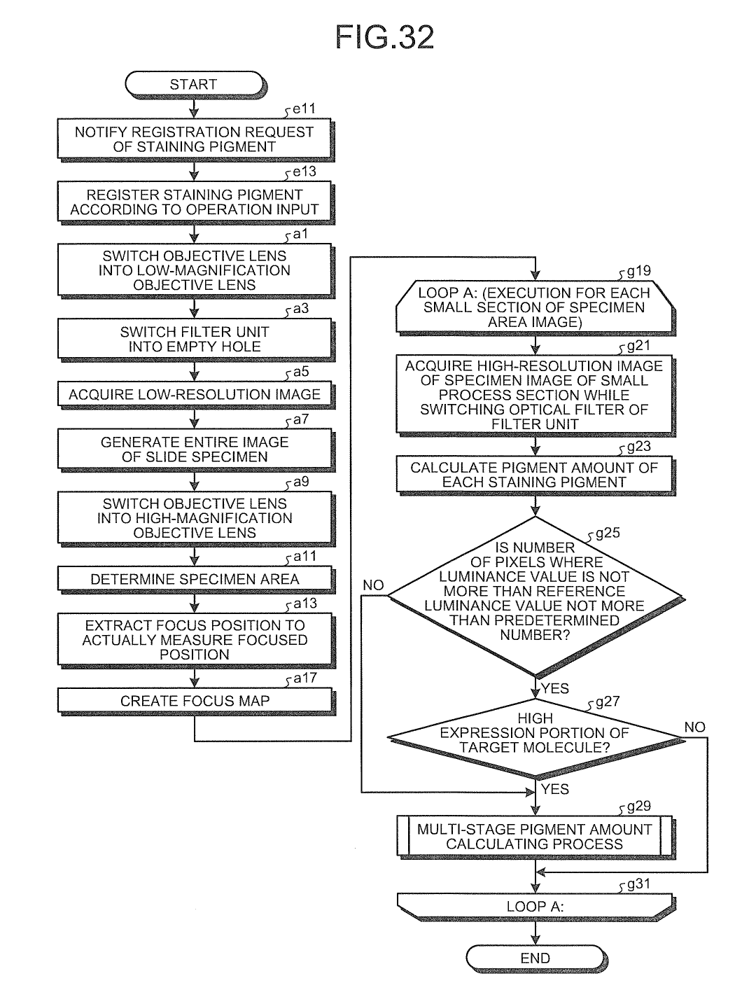

In the fifth embodiment, the multi-stage pigment amount calculating process is always executed. However, when the predetermined condition is satisfied, the multi-stage pigment amount calculating process may be executed. FIG. 32 is a flowchart illustrating the operation of a microscope system that is realized by a VS image generating process according to a modification. In the modification, the same processes as those of the fifth embodiment are denoted by the same reference numerals.

As illustrated in FIG. 32, according to the modification, after the focus map is created in step a17, a process of a loop A is executed for each small section of the specimen area image (steps g19 to g31). Hereinafter, the small section of the specimen area image that becomes the target of the process of the loop A is referred to as a “small process section”.

First, the high-resolution image acquisition processing unit 453d outputs an instruction, which causes the optical filters for capturing the specimen with multi-bands to be sequentially switched, to the microscope controller, outputs an operation instruction of each unit of the microscope apparatus to the microscope controller or the TV camera controller, captures a specimen image of the small process section with multi-bands, and acquires a high-resolution image (specimen area section image) (Step g21). Next, the pigment amount calculating unit 460d calculates the pigment amount at each specimen position on the specimen corresponding to the small process section for each staining pigment, on the basis of a pixel value of each pixel of the acquired specimen area section image (Step g23).

Next, the VS image generating unit 451d counts the number of pixels whose luminance values are smaller than or equal to the reference luminance value set in advance, on the basis of the pixel values of the specimen area section images, and determines brightness of the specimen area section images as a brightness determining unit. When the number of pixels is larger than the predetermined number, that is, the specimen area section images are dark (Step g25: No), the VS image generating unit 451d proceeds to the multi-stage pigment amount calculating process (Step g29).

When the number of pixels whose luminance values are smaller than or equal to the reference luminance value is smaller than or equal to the predetermined number (Step g25: Yes), the VS image generating unit 451d determines whether the small process section is a high expression portion of the target molecule. Specifically, the VS image generating unit 451d counts the number of pixels (high-concentration areas) where the pigment amount of the DAB pigment corresponding to the molecule target pigment is equal to or larger than the predetermined threshold value, among the pixels constituting the specimen area section images. Next, the VS image generating unit 451d determines whether the high-concentration area is wider than the predetermined area, on the basis of the number of pixels. When the high-concentration area is wider than the predetermined area, the VS image generating unit 451d determines the small process section as the high expression portion of the target molecule. As the determination result, if the small process section is not the high expression portion of the target molecule (Step g27: No), the process of the loop A is completed with respect to the small process section.

Meanwhile, when the high expression portion exists (Step g27: Yes), the VS image generating unit 451d proceeds to the multi-stage pigment amount calculating process (Step g29). If the process of the loop A is executed with respect to all of the small sections of the specimen area image, the process is completed.

According to this modification, among the small sections of the specimen area image, with respect to the small sections where the number of pixels whose luminance values are smaller than or equal to the reference luminance value is larger than the predetermined number, the multi-stage pigment amount calculating process can be executed, the specimen area section images captured while the exposure condition is stepwisely varied can be acquired, and the pigment amount can be calculated. That is, with respect to the small sections having the predetermined brightness, the multi-stage pigment amount calculating process is not executed. With respect to the small section that is determined as the high expression portion of the target molecule, the multi-stage pigment amount calculating process is executed, the specimen area section images captured while the exposure condition is stepwisely varied can be acquired, and the pigment amount can be calculated. For example, when the expression of the target molecule by the molecule target staining increases in the predetermined range and can be visualized, the expression portion may become an expression evaluation target. In consideration of this circumstance in advance, the multi-stage pigment amount calculating process can be appropriately executed. Accordingly, process efficiency can be improved and a process time can be shortened.

In this modification, with respect to the dark small sections where the number of pixels whose luminance values are smaller than or equal to the reference luminance value is larger than the predetermined number, the multi-stage pigment amount calculating process is executed. However, the invention is not limited thereto, and the multi-stage pigment amount calculating process may be executed when the number of pixels whose luminance values are smaller than or equal to the reference luminance value is larger than the predetermined number and the pixels of the small sections include the pixel of the specimen position stained by the DAB pigment.

According to the invention, the display image where the staining state of the specimen by the display target pigment is displayed can be generated on the basis of the pigment amount of the display target pigment selected from the plurality of pigments staining the specimen, and can be displayed on the display unit. Accordingly, the specimen image that is obtained by capturing the specimen multi-stained by the plurality of pigments can be displayed with high visibility.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A microscope system, comprising:
an image acquiring unit that acquires a specimen image formed by capturing a specimen multi-stained by a plurality of pigments using a microscope;
a pigment amount acquiring unit that acquires a pigment amount of each pigment staining a corresponding position on the specimen, for each pixel of the specimen image;
a pigment selecting unit that selects a display target pigment from the plurality of pigments;
a display image generating unit that generates a display image where a staining state of the specimen by the display target pigment is displayed, on the basis of the pigment amount of the display target pigment in each pixel of the specimen image; and
a display processing unit that displays the display image on a display unit.

2. The microscope system according to claim 1, further comprising:
a pigment selection requesting unit that requests to select at least one pigment of the plurality of pigments,
wherein the pigment selecting unit selects the pigment selected in response to the request from the pigment selection requesting unit as the display target pigment.

3. The microscope system according to claim 1, further comprising:
a pigment amount correcting unit that corrects the pigment amount acquired by the pigment amount acquiring unit with respect to the display target pigment using a predetermined correction coefficient,
wherein the display image generating unit generates the display image, on the basis of the pigment amount of the display target pigment corrected by the pigment amount correcting unit.

4. The microscope system according to claim 1, further comprising:
a display color allocating unit that allocates a display color, which is used to display a staining state by a predetermined pigment among the plurality of pigments, to the predetermined pigment,
wherein, when the display color is allocated to the display target pigment by the display color allocating unit, the display image generating unit generates a display image where the staining state of the specimen by the display target pigment is displayed by the allocated display color, on the basis of the pigment amount of the display target pigment.

5. The microscope system according to claim 4,
wherein the display image generating unit calculates a pixel value of the display image using a spectral characteristic of the allocated display color, on the basis of the pigment amount of the display target pigment, and generates the display image.

6. The microscope system according to claim 5, wherein
the plurality of pigments include a molecule target pigment that stains the specimen by labeling an expression of a predetermined target molecule, and
the display color allocating unit allocates the display color to the molecule target pigment.

7. The microscope system according to claim 1, wherein
the image acquiring unit captures each portion of the specimen while relatively moving the specimen and an objective lens in a plane orthogonal to an optical axis of the objective lens, and acquires a plurality of specimen images, and
the image acquiring unit includes a specimen image generating unit configured to generate a specimen image by synthesizing the plurality of specimen images.

8. The microscope system according to claim 1, further comprising:
an attention area setting unit that sets an attention area in the specimen image;
a magnification changing unit that changes an observation magnification of the specimen by the microscope to an observation magnification higher than an observation magnification of the specimen of when the specimen image is acquired; and
an attention area image acquiring unit that acquires an attention area image formed by capturing the attention area with the observation magnification changed by the magnification changing unit.

9. The microscope system according to claim 8, wherein
the plurality of pigments include a molecule target pigment that stains the specimen by labeling an expression of a predetermined target molecule, and
the attention area setting unit extracts a high expression portion of the target molecule labeled by the molecule target pigment, and sets the high expression portion as the attention area.

10. The microscope system according to claim 8, wherein
the attention area setting unit extracts a low-luminance portion from the specimen image and sets the low-luminance portion as the attention area.

11. The microscope system according to claim 8, wherein
the attention area image acquiring unit acquires a plurality of attention area images formed by capturing the attention area, while varying a relative distance of the specimen and the objective lens along an optical-axis direction of the objective lens.

12. The microscope system according to claim 1, wherein
the image acquiring unit includes an exposure condition setting unit configured to stepwisely set an exposure condition of when the specimen is captured, and acquires the specimen image according to the exposure condition set by the exposure condition setting unit.

13. The microscope system according to claim 12, further comprising a brightness determining unit configured to determine brightness of the specimen image acquired by the image acquiring unit,
wherein the exposure condition setting unit stepwisely sets the exposure condition according to the brightness determined by the brightness determining unit.

14. The microscope system according to claim 12, wherein the exposure condition setting unit stepwisely sets the exposure condition, when positions on the specimen corresponding to pixels constituting the specimen image acquired by the image acquiring unit are stained by the predetermined pigment.

15. The microscope system according to claim 12, wherein the exposure condition setting unit stepwisely sets the exposure condition, when positions on the specimen corresponding to pixels constituting the specimen image acquired by the image acquiring unit are stained by the predetermined pigment and an area occupied by the stained positions in the specimen image is equal to or larger than a predetermined area.

16. A specimen observing method, comprising:
acquiring a pigment amount of each pigment staining a corresponding position on a specimen, for each pixel of a specimen image obtained by capturing a specimen multi-stained by a plurality of pigments;
a pigment selecting unit that selects a display target pigment from the plurality of pigments;
a display image generating unit that generates a display image where a staining state of the specimen by the display target pigment is displayed, on the basis of the pigment amount of the display target pigment in each pixel of the specimen image; and
a display processing unit that displays the display image on a display unit.

17. A computer program product having a computer readable medium including programmed instructions, wherein the instructions, when executed by a computer, cause the computer to perform:
acquiring a pigment amount of each pigment staining a corresponding position on a specimen, for each pixel of a specimen image obtained by capturing a specimen multi-stained by a plurality of pigments;
a pigment selecting unit that selects a display target pigment from the plurality of pigments;
a display image generating unit that generates a display image where a staining state of the specimen by the display target pigment is displayed, on the basis of the pigment amount of the display target pigment in each pixel of the specimen image; and
a display processing unit that displays the display image on a display unit.
